(19) United States
(12) Patent Application Publication
(10) Pub. No.: US 2018/0025303 A1
(43) Pub. Date: Jan. 25, 2018

(54) SYSTEM AND METHOD FOR COMPUTERIZED PREDICTIVE PERFORMANCE ANALYSIS OF NATURAL LANGUAGE

(71) Applicant: Plenarium Inc., Minneapolis, MN (US)

(72) Inventor: John Thomas Janz, Boca Raton, FL (US)

(21) Appl. No.: 15/655,503

(22) Filed: Jul. 20, 2017

Related U.S. Application Data
(60) Provisional application No. 62/364,400, filed on Jul. 20, 2016.

(51) Int. Cl. G06Q 10/06; G06F 19/00

(52) U.S. Cl. CPC G06Q 10/0639; G06F 19/34

(57) ABSTRACT

A method of behavior assessment or performance prediction, comprising: acquiring a video stream of an interviewee responding to a set of interview prompts or a corpus of documents of a subject; analyzing at least the semantic content of the video stream or corpus; statistically processing, with at least one automated processor, the semantic content according to a correspondence of the interviewee's response or subject's corpus to a set of classified exemplar responses, and a context, to classify the interviewee or subject with respect to the context; and generating at least one output selectively dependent on the classification of the interviewee or subject.

### CROSS REFERENCE TO RELATED APPLICATIONS

The present application is a non-provisional of, and claims benefit of priority from, U.S. Provisional Patent Application No. 62/364,400, filed Jul. 20, 2016, the entirety of which is expressly incorporated herein by reference.

### BACKGROUND OF THE INVENTION

### Field of the Invention

The present invention relates to the field of computerized psychological analysis of digitized communications, to produce support for talent optimization and talent risk mitigation, including warnings of potentially damaging behavior for the employee and the corporation.

### Description of the Relevant Art

Psychological assessments are well known. Typically, these take the form of observation by a trained psychologist or social scientist, or a predefined test composed of validated items with quantitative, discrete responses that are subject to analysis. In less structured environments, reliance on psychological assessments is difficult and has been considered unreliable.

Candidate Analysis

According to a known system, candidates are presented with opportunities to provide narrative descriptions related to a topic. In many existing applications, it is customary for prospective candidates to provide a narrative that is appropriate for the type of candidacy at issue. For example, for a recruiting application, the candidate might provide a narrative description of the preferred working environment and personal qualities that make him a desirable candidate. Requests for narrative information on customary topics will generally be regarded as a normal and expected part of a candidate-matching system, and customary topics may therefore be preferable. However, the topics are not limited to the collection of narrative on customary topics, and narrative may be collected on any topic, including randomly-selected topics. The selected topic is not critical because the technology analyzes the provided narrative to develop one or more metrics concerning the manner in which the narrative is expressed. For example, algorithms may be used to score the provided narrative on the basis of vocabulary employed, grammar, spelling, and sentence structure. More sophisticated algorithms may be employed to make use of these and other factors to provide estimates of IQ, educational level, language proficiency, personality type, or other parameters of interest. Any suitable method of writing analysis may be used. Results of the writing analysis may be collected in a database, in association with the candidate profile.

The analyzed metrics may then be used in formulating query responses in various different ways. For example, users may be permitted to specify queries that make direct use of the metrics developed from the writing analysis. For example, a user may be able to specify that a certain level of writing ability is desired, such as “greater than high school” but “less than post-graduate.” In the alternative, or in addition, users may specify other parameters that are candidate-supplied, for example, age, education level, and languages spoken, and the metrics from the writing analysis may be applied to gauge the reliability of the candidate-supplied answers. Results may be ranked in order of reliability, and/or a reliability estimate may be provided as a graphical indicator, or in a textual field.

In another known technology, a telephonic communication between a customer and a contact center is analyzed. The telephonic communication is separated into constituent voice components. The voice data is mined by applying a predetermined linguistic-based psychological behavioral model, and behavioral assessment data is generated that corresponds to the analyzed voice data. Certain psychological behavioral models have been developed as tools to evaluate and understand how and/or why one person or a group of people interacts with another person or group of people.

Another known technology predicts user behavior based on analysis of a user video communication. A user video communication is received, and video facial analysis data and voice analysis data are extracted. The video facial analysis data is associated with the voice analysis data to determine an emotional state of a user. biographical profile information specific to the user is collected, and a linguistic-based psychological behavioral model applied to the spoken words, in order to determine personality type of the user. The collected biographical profile information, emotional state, and personality type are inputted into a predictive model to determine a likelihood of an outcome of the video communication.

Video analysis may include and apply a number of video analytics or video content analysis algorithms. These algorithms typically utilize a combination of computer vision, pattern analysis, and machine intelligence to detect, recognize, or otherwise sense visual objects. Video analytics uses computer vision algorithms to enable it to perceive or see—and machine intelligence to interpret, learn and draw—inferences. Video analytics can understand a scene, and can qualify an object, understand the context around the object, and track the object through the scene. Commonly, video analytics detect changes occurring over successive frames of video, qualify these changes in each frame, correlate qualified changes over multiple frames, and interpret these correlated changes.

Objects recognizable by video analytics can take many forms. Examples include bodily or body part movements, positions and relative orientations (e.g., gaze direction, bodily movements and gestures such as expressions or moods/emotions denoting anger, shock, surprise, panic or fear, and the like, mannerisms, styles, bodily poses, and the like), facial expressions, attire including articles or items of clothing and accessories such as jewelry and mobile devices, non-human objects in the foreground or background (such as cars, animals, lights and light colors—such as of an emergency vehicle—trees, snow, and the like), or human objects in the foreground or background. Certain types of attire can be determined using any technique, method, or software available to those of ordinary skill in the art. For example, such software is commercially available from Graymatics.

Psychological profiling algorithms have been developed based upon the work of Walter Weintraub (1964). Weintraub has identified 14 critical speech categories, which are believed by various psychologists to reflect the operation of psychological coping mechanisms or defenses. Weintraub's opinion is that the distribution of these variables indicate the distribution of defenses in an individual and provides insight into the individual's psychological state or personality. Weintraub's and his colleague's original research dates from 1964. This research demonstrated differences in the distribution of these categories of speech as used by normal persons and persons with different forms of psychopathology, including depression, impulsiveness, delusions and compulsiveness. Weintraub profiled and compared political leaders, such as participants in Watergate in 1981. In 1989, he extended his methodology for leadership profiling to the assessment and comparison of U.S. Presidents, including Eisenhower, Kennedy, Johnson, Nixon, Ford, Carter and Reagan. Weintraub's algorithms have also been used to analyze the speech and written products of leaders to develop in-depth psychological profiles of these individuals and comparisons between them. Weintraub has also discussed providing computerized portions of his algorithms to expedite the analytical process. They have been proposed for application to the evaluations of changes in an individual's psychological state over time; the communications of normal employees in the workplace; to computer generated communications, e.g. email and chat; generating a warning of a potentially dangerous change in an individual's psychological state; or self-monitoring of psychological state. The Weintraub algorithms quantify the number of words in the speech categories.

Weintraub identified 14 critical speech categories:

1. QUANTITY OF SPEECH

2. LONG PAUSES

3. RATE OF SPEECH

4. NONPERSONAL REFERENCES

5. I

6. WE

7. ME

8. NEGATIVES

9. QUALIFIERS

10. RETRACTORS

11. DIRECT REFERENCES

12. EXPLAINERS

13. EXPRESSIONS OF FEELINGS

14. EVALUATORS

The Weintraub algorithms may be used to profile the following psychological states:

1. Indicators of Anger—Increases in the number of: words; personal references; negatives; evaluators; statements of feeling; direct references; rhetorical questions; interruptions; use of “I”; and “We” Decreases in the number of: qualifiers; and retractors.

2. Indicators of Anxiety—Increases in the number of: retractors; qualifiers; expressions of feeling; negatives; and explainers.

3. Indicators of Depression—decreased number of words; increased “I”; increased “me”; increased negative key words; increased direct references; increased expressions of feeling key words; increased evaluators; increased adverbial intensifiers

4. Indicators of Emotional withdrawal—decreased number of words; decreased number of communications; decreased “I” score; decreased personal references; decreased expressions of feelings; and decreased evaluators.

5. Indicators of Rigidity or lack of flexibility—decreased number of qualifiers; decreased number of retractors; decreased “we's”; increased “I's”; decreased explainers; increased evaluators; and increased adverbial intensifiers.

6. Indicators of Impulsiveness—increased retractors and increased expressions of feeling.

7. Indicators of Emotional instability—increased “I”-to-“We” ratio; increased adverbial intensifiers increased direct references increased expression of feelings increased evaluators.

Score Interpretations of Weintraub's psychological profiling algorithms have been suggested as follows:

1. “I” scores: high “I” score—self-preoccupied moderate “I”—healthy ability to commit self in thought and action while maintaining degree of autonomy; low “I”—avoidance of candor, intimacy, commitment.

2. “We” scores: moderate score—healthy capacity to recognize and collaborate with others high “we” plus low “I”—avoidance of intimacy and commitment.

3. “Me”: high use reflects dependence and passivity.

4. Negatives: high scores associated with stubbornness, opposition, anger, use of denial as defense mechanism.

5. Qualifiers low score—dogmatism—over-certainty, rigidity. high score—lack of decisiveness, avoidance of commitment very high score—anxiety.

6. Retractors high score—difficulty adhering to previous decisions, impulsiveness moderate—mature capacity to reconsider, flexibility, openness to new possibility. very low—dogmatism, rigidity.

7. Direct References high scores—difficulty with correspondence or conversation, seeking to distract or manipulate low or absent—shyness, aloofness, anxiety.

8. Explainers high—use of rationalization low or absent—dogmatism, rigidity.

9. Expressions of Feeling low score—aloofness, hesitant to share feelings, trust high score—insincere, histrionic.

10. Evaluators high scores—severe or troubled conscience, psychopathology, anger, dogmatism, rigidity Low scores—fear of intimacy, lack of commitment.

11. Adverbial Intensifiers high scores indicate histrionic personality, exaggeration, rigidity, judgmental.

12. Rhetorical Questions—increase anger and an effort to control the dialogue.

13. Interruptions—increased anger and an effort to dominate.

The specialized composite scores with relevance for personal relationships, organizational behavior and leadership remain unpublished but include: emotionally controlled—low anxiety and depression scores sensitivity to criticism—high negatives plus high explainers plus high “I” and “me”. accommodating versus rivalrous—low to moderate negatives and moderate to high retractors oppositional-high negatives score. controlling in relationships—low score on negatives, feelings, evaluators, and qualifiers. passive vs. active—high me score. planner vs. reactor—high “I” and “we”:“me” ratio. decisiveness—low to moderate qualifiers. unrealistic—high negatives. high need for others—high “we”. high need for achievement—high “I” and “We”, low “me”, low qualifiers. dependent-high me plus high evaluators, negatives, feelings. well organized—high “I” and “we”, low “me”, low qualifiers, low evaluators, ow feelings, low negatives. narcissistic—high negatives and high explainers and high evaluators, high “I”, low qualifiers. obsessive—high evaluators plus high negatives plus low retractors, low “me”, low qualifiers, low feelings paranoid—high negatives, high explainers, low retractors. loner vs. team player—high “I”, low “we” or “I”:“We”.

Gottschalk and his colleagues have produced a content analytical system that can detect emotional states and changes in emotional states in individuals as a result of a wide range of psychological and medical conditions and treatments. The have also measured changes in these states in individuals over time and designed a computerized version of the system. Later proposals utilized Gottschalk's algorithms regarding communications of normal employees in the workplace, computer generated communications, e.g. email and chat, the generation of a warning of a potentially dangerous change in an individual's psychological state or self-monitoring of a psychological state.

Margaret Hermann used content analysis for psychological profiling, especially of important leaders. Hermann uses scores obtained on a leader for each of the aforementioned eight personal characteristics and uses them to classify the leader in terms of six possible foreign policy orientations, including expansionist, active independent, influential, opportunist, mediator and developmental. Each of the orientation types can be expected to differ in world view, political style, decision-making process manner of dealing with political rivals, and in view of foreign policy. Hermann has designed computerized approaches to her content analytical system. However, the complexity of coding required to produce measures for many of the characteristics has limited validity and reliability of the resultant automated process.

Another measure of psychological state is described in Mehrabian and Wiener (1966) and is identified as “Psychological Distance”. Psychological distance is an emotional state expressed by the speaker toward a target, individual or group. Because the speaker normally unconsciously selects the semantic structures used to calculate psychological distance, it is a measure of “covert” attitude. When a speaker's covert attitude, as measured by psychological distances, is compared with overt content of a speaker's remarks (the number of negative, positive or neutral words associated with the name of an individual or group), it becomes a reliable measure of deception or bluffing. For example, if the overt attitude toward the person or group is positive and the covert attitude is negative, this is an indicator of deception. If the covert attitude towards the group or individual is more positive than the overt attitude, this is an indicator of bluffing. Psychological distance is scored according to the following guidelines. First, each reference by the speaker to the target is identified. Second, the word structures around the reference to the target are evaluated for the presence or absence of each of the nine conditions below. Third, for each time one of these nine conditions is present, a single score is received. Fourth, for each communication, an average psychological distance score is constructed by taking the number of references to the target divided by the number of points received in the communication across all references to the target. This score is usually between one and nine, with the higher score indicating the presence of greater hostility or psychological distance.

The Mehrabian-Wiener Psychological Distance Coding Guidelines run as follows:

1. Spatial: the communicator refers to the object of communication using demonstrative pronouns such as “that” or “those.” E.g. “those people need help” versus “these people need help.”

2. Temporal: the communicator's relationship with the object of communication is either temporally past or future. E.g., “X has been showing me his house” versus “X is showing me his house.”

3. Passivity: the relationship between the communicator and the object of communication is imposed on either or both of them. E.g., “I have to see X” versus “I want to see X.”

4. Unilaterally: the relationship between communicator and the object of communication is not mutually determined. E.g., “I am dancing with X” versus “X and I are dancing.”

5. Possibility: the relationship between the communicator and the object of communication is possible rather than actual. E.g., “I could see X” versus “I want to see X.”

6. Part (of Communicator): only a part, aspect, or characteristic of the communicator is involved in the relationship with the object of communication. E.g., “My thoughts are about X” versus “I am thinking of X.”

7. Object (Part of Object): only a part, aspect, or characteristic of the object of communication is involved in the relationship with the communicator. E.g., “I am concerned about X's future” versus “I am concerned about X.”

8. Class (of Communicator): a group of people who include the communicator is related to the object of communication. E.g., “X came to visit us” versus “X came to visit me.”

9. Class (of Object): the object of communication is related to as a group of objects, which includes the object of communication, e.g., “I visited X and his wife” versus “I visited X.”

Eric Shaw's firm, Stroz Friedberg, Inc., developed psycholinguistic measures sensitive to changes in an employee's psychological state indicative of increased risk. In the case of the employee who abruptly changes tone in his email messages, post hoc use of these measures detected both the employee's initial disgruntlement and the contrast between his overt and covert activities. See U.S. Pat. No. 8,775,162. This technology was applied to analyze electronic mail messages of an actual perpetrator of a computer crime. The mean prior values of the number of “negatives”, the number of “evaluators”, the “number of words per email”, and the “number of alert phrases”, were compared to the values obtained from analysis of an electronic mail message prior to and associated with the crime in question. The increase over the mean values was discussed as indicating the risk of the criminal activity in question. Email-monitoring software for the securities industry has been developed as a result of a SEC order that brokerage houses monitor their sales force for illegal sales practices. This software detects key words indicative of potential trading sales violations.

According to Shaw's technology, at least one computer generated communication produced by or received by an author is collected; such communication is parsed to identify categories of information therein; and the categories of information are processed with at least one analysis to quantify at least one type of information in each category, such as specific words and word phrases which provide information about psychological state of the author and are sensitive indicators of the changes in the psychological state of the author. An output communication is generated when the quantification of at least one type of information for at least one category differs from a reference for the at least one category by at least one criterion involving a psychological state of the author in response to which it would be wise or beneficial to take a responsive action. The content of the output communication and the criteria are programmable to define when an action should be taken in response to the psychological state and a suggested action (a warning, counseling or otherwise) to be taken in response to the psychological state.

A plurality of computer generated communications generated over a period of time may be collected, parsed and processed to generate the reference of the at least one type of information for each category. A more recent computer generated communication may be collected and parsed to quantify the at least one type of information therein for each category with the output communication being generated when a comparison of the reference based upon previous computer generated communications of the at least one category and the quantification of the current computer generated communication for at least one category reveals a change which differs from the reference from the at least one category by the criteria. The plurality of analyses may comprise a psychological profiling algorithm that provides an indication of psychological state of the author, at least one key word algorithm that processes any phrases and/or threatening acts to further identify a psychological state of the author and how the author may react to the identified psychological state and at least one communication characteristic algorithm that analyzes characteristics of the at least one computer generated communication to further identify a psychological state and/or at least one possible action of the author.

A method of computer analysis of computer generated communications in accordance with Shaw's technology includes collecting at least one computer generated communication produced by or received by an author; parsing the collected at least one computer generated communication to identify categories of information therein; processing the categories of information with at least one analysis to quantify at least one type of information in each category; and generating an output communication when a difference between the quantification of at least one type of information for at least one category and a reference for the at least one category is detected involving a psychological state of the author to which a responsive action should be taken with content of the output communication and the at least one category being programmable to define a psychological state in response to which an action should be taken and what the action is to be taken in response to the defined psychological state. The method further may include a plurality of computer generated communications generated over a period of time that are collected, parsed and processed to generate the reference of the at least one type of information for each category; collecting, parsing and processing a more recent computer generated communication to quantify the at least one type of information therein for each category; and generating the output communication when the difference between the reference of at least one category and the quantification of the current computer generated communication for at least one category is detected involving a psychological state of the author to which the responsive action should be taken.

Only one computer generated communication may be collected, parsed and processed. The output communication may indicate that the author should be studied. One or more analyses may be used to process the categories of information with the analyses including one or more of a psychological profiling algorithm that provides an indication of a psychological state of the author, at least one key word algorithm that processes any phrases and/or threatening acts to further identify a psychological state of the author and how the author may react to the identified psychological state and at least one communication characteristic algorithm that analyzes characteristics of the at least one computer generated communication to identify a psychological state and/or at least one possible action of the author. The at least one computer generated communication may be collected by an organization to which the author is affiliated; and the output communication may be present on a system of the organization and is directed to or from the organization. Each reference may be set by the organization.

Only one computer generated communication may be collected by an organization to which the author is affiliated; and the output communication may be directed to the organization and pertains to further action to be taken regarding the author. Each reference may be static and indicative that a psychological state of the author is of concern to the organization. The collected at least one computer generated communication may be email, chat from a chat room or website information collected from a website. The output communication may assess a risk posed by the author based upon the at least one computer generated communication produced or received by the author. The author may be affiliated with an organization; and the output communication may pertain to a course of action to be taken by the organization that collected the at least one computer generated communication authored or received by the author. The output communication may be about the author; and the output communication may be generated in response to processing of the reference for the at least one psychological profiling algorithm and the quantification produced by the psychological profiling algorithm, may be generated in response to processing of the reference for the at least one key word algorithm and the quantification produced by the at least one key word algorithm, or it may be generated in response to a comparison of the reference for the at least one communication characteristic algorithm and the quantification produced by the at least one communication characteristic algorithm. The output communication may regard at least one of a psychological state of the author represented in the at least one computer generated communication and an investigation of the psychological state of the author represented by the at least one computer generated communication. The at least one psychological profiling algorithm may quantify at least one of: words written in bold face, italics, profanity or email symbols in an alert phrase. The at least one psychological profiling algorithm may quantify the following words, phrases, or subjects: “I”, “we”, “me” negatives, quantifiers, retractors, direct references, explainers, expressions of feeling, evaluators, adverbial intensifiers, rhetorical questions, interruptions, interrogatives and imperatives. The at least one psychological profiling algorithm produces an assessment of a psychological state of the author. The psychological state of the author may be at least one of anger, anxiety, depression, emotional withdrawal, lack of flexibility, impulsiveness and emotional stability.

The at least one key word algorithm may provide an interpretation of the psychological state and/or risk of at least one of or a combination of the words, phrases and subjects represented by the at least one computer generated communication. The at least one key word algorithm may quantify phrases and/or threatening acts to identify a psychological state. The phrases and/or threatening acts may involve at least one of anger, grief, threats, or accusations. The at least one key word algorithm may provide information regarding at least one of: employee attitude, actions toward individuals, at least one organization and at least one organizational interest. The message characteristics algorithms of the at least one computer generated communication may include at least one of the following information about the at least one computer generated communication: number of words, time of day, writing time, number of words per minute, recipient, spelling errors, grammatical errors, words per sentence, and communication rate in terms of at least one of a number of computer generated communications per hour or day. The output communication may be used to alter the at least one computer generated communication. In the self-monitoring version, the author may use the output communication to alter the at least one computer generated communication. The altering of the at least one computer generated communication may modify a psychological state reflected in the at least one computer generated communication in a manner desired by the author. The category involving psychological state may be a change in psychological state.

Finding and hiring employees is a task that impacts most modern businesses. It is important for an employer to find employees that deliver the greatest amount of performance-generated value once hired, when compared against other candidates who have expressed interest in the job. Criteria for fitting an open position may include skills necessary to perform job functions. Employers may also want to evaluate potential employees for mental and emotional stability, ability to work well with others, ability to assume leadership roles, ambition, attention to detail, problem solving, etc.

However, the processes associated with finding employees can be expensive and time consuming for an employer. Such processes can include evaluating resumes and cover letters, telephone interviews with candidates, in-person interviews with candidates, drug testing, skill testing, sending rejection letters, offer negotiation, training new employees, etc. A single employee candidate can be very costly in terms of man-hours needed to evaluate and interact with the candidate before the candidate is hired.

Computers and computing systems can be used to automate some of these activities. For example, many businesses now have on-line recruiting tools that facilitate job postings, resume submissions, preliminary evaluations, etc. Additionally, some computing systems include functionality for allowing candidates to participate in “virtual” on-line interviews.

While computing tools have automated interview response gathering, there is still substantial time, expense, and opportunities to derail the quality of talent decisions present in the initial respondent screening and answer evaluation phase of the interview. While some hiring managers interview diligently, stick to questions proven in research to predict future job performance, actively coach candidates back to answering those questions when they stray from the content requested by the question, take comprehensive and discernable notes, evaluate interview answers using those notes against clearly defined behavioral anchors for superlative vs deficient answers, few hiring managers actually follow these laudatory practices. Most revert to traditional or personally favored questions known to contribute little to predicting job performance, let the candidate veer away from the question or ramble on, or take sketchy or illegible notes, when they take notes at all. Then when it comes to evaluating candidate answers, interviewers often simply rank candidates vs. rate answers, picking the “winners” based on personal impression formed more on how the candidate answered the questions vs. what was actually said. Taken as a whole, these common practices lead to extensive decision failures at the conclusion of this final step in deciding who receives offers of employment.

The job of interviewers and candidate reviewers is to determine if candidates are skilled and have the characteristics required to deliver optimal performance value once hired for a particular job. In the process of doing this, they compare and contrast the qualifications of candidates—often reviewing and comparing candidate responses to particular questions. The result is that responses are often not evaluated equally, fairly or in light of other candidate responses.

Evaluation of candidates can be a very subjective and invidiously prejudicial process that is highly dependent on individual interviewers. However, large organizations may wish to remove or minimize subjectivity to maximize recruiting efforts, avoid charges of discrimination, and to thus maximize the performance value of those who accept offers of employment.

The subject matter claimed herein illustrates an exemplary technology that eliminates the bad practices common among hiring managers by eliminating hiring managers from the pre-employment screening interview entirely. This technology empowers hiring teams to deploy the maximum power of people science (Industrial/Organizational Psychology) to objectively zero in on the very best talent from those interested in joining the firm, with a minimal possibility of bias exercised against protected classes. Instead of relying on fallible subjective processes to screen out ineligible or unsuitable talent and form short lists of four to eight finalists for on-site interviews, an objective process, culminating with the fully automated behavioral interviewing process herein described may be deployed to identify the person most likely to succeed, proceeding to the next most likely person should the most likely person generate insufficient confidence for the hiring team following an on-site or in-person interview process.

The prevalence of the interview in the hiring process has been well documented (Campion, Palmer, and Campion; 1997; Hough and Oswald; 2000), as has the consistent decision power of behavior description interviewing in reported research for predicting job performance (Janz, 1982, Weisner and Cronshaw, 1988; Schmidt and Hunter, 1998; Huffcutt and Arthur, 1994, Sackett and Lievans, 2008). The accuracy of selection decisions rendered by the traditional, unstructured one-on-one interview has been investigated in over 60 studies, averaging roughly just 20% of the value of a perfect predictor. Given that even the best predictors average 60% of perfection, unstructured interviews capture only ⅓ of that more feasible goal. Structured behavioral interviews do much better in research studies, averaging closer to 50% of potential value or 83% of the feasible value, and they produce less adverse impact than cognitive ability tests as well as much less costly than work simulations.

Most large organizations train their recruiters and hiring managers in one or another form of behavioral interviewing (Janz, Hellervik, and Gilmore, 1987; Janz 1989). Yet many seasoned practitioners (Wheeler, 2011, “Why Interviews are a Waste of Time”), including this author, have questioned the practical power of behavioral interviewing in the field. Making hiring decisions under field conditions where: (a) interviewers often have varying levels of training (or were trained at different times), (b) the hirer falls under pressure to reduce time-to-fill while keeping the cost per hire under control, and (c) the hirer's primary duties occupy more than a full time job as it is, leads to shortcuts that undermine the power found in research studies.

As a result, it has been observed that the following five “worst practices” are the norm:

1. Few field interviewers (not participating in a research study) take anything but the most cursory of notes—that they themselves find it difficult to decipher 20 minutes after they were taken.

2. Field interviewers (other than professional assessors) rarely rate each interview answer on behavioral (or any other kind of) scales, summing the ratings to form a total score.

3. Field interviewers often fail to hear when candidates answer a behavioral question with a non-behavioral answer, allowing (and even encouraging) candidates to go on about their preferences and advice instead of collecting specific past performance to job-related challenges.

4. Many interviewers fill silence that occurs during an interview by either suggesting what they seek (telegraphing the ideal answer) or moving on to the next question.

5. Field interviewers rarely seek confirmation, or even the means of confirmation, for the specific examples of past performance that they collect.

Beyond these five limitations of interviewing practice, behavioral interviewing is normally applied to the four to six finalist candidates, relying on resume sorts, telephone screening interviews, or Boolean text searches to pick the candidates who make it onto the short list from the 15 to as many as 400 that initially respond. These alternative screening methods have low decision power, resulting in high screening error rates of two types. The false positives add labor cost to a selection strategy by lengthening the short list to four to six from the two to three required if there were an efficient way to accurately pick the performers from the pretenders at the top of the funnel. At least false positives can be caught in final decision behavioral interviews—if only they enjoyed the full decision power found in studies. The false negatives lower the average performance value of those hired by falsely ruling out superior talent early in the process.

Hiring decision power is measured by the correlation between interview score and a measure of performance on the job. A correlation is an abstract statistical number, but it directly reflects the proportion of potential talent value that the selection strategy (the interview in this case) delivers to the job. So a value of 0.50 for a staffing strategy means that this strategy captures 50% of the potential talent value that would have been captured by a strategy that hired only the very best talent from those that applied.

It would be nice if we could directly assess the decision power of interview-based staffing decisions made in the field, but that is precisely why there is a gap. It's analogous to the uncertainty principle in quantum physics, where the very act of measuring a particle causes it to change. Instead, I will draw on experience and related research to estimate the gap. Initially, I will focus on the first two causes for the gap listed above-poor note taking and the failure to rate each answer and combine the ratings to evaluate the candidate. Then I turn attention to the lack of confirmation details and the placement of the interview at the bottom of the funnel.

Early research on the interview by Ed Webster found interviewers to be in a hurry to remove doubt from the process and reach quick decisions about candidates. Such interviewers believe that they don't need to take notes or evaluate every question, because they have already made up their minds. Careful interviewers following their behavioral interview training ask questions from their interview guides, probe to make sure they acquire a specific, behavior description (or intention), take readable notes, and rate each answer against the behavioral anchors provided in the guide. When the doors close in the field, interviewers often do the minimum—ask a couple of questions from the guide. When they revert to the Ed Webster described practices (take poor if any notes and evaluate the candidate on one scale), they damage the decision power potential of the behavioral interview by from 10-20 points. Thus 0.53 becomes 0.33-0.43.

Turning to the fifth item on the poor practices list above, how much additional decision power could be gained if there were a way to confirm each of the candidate's answers? Behavioral interviewing practice in the currently reported research does not collect such confirmations. While confirming each answer presents practical problems, the benefits of having independent answer confirmation are obvious. I estimate that it would add at least 5-7 points of decision power, raising the 0.53 to from 0.58-0.60. Thus a best practices field approach that combined great note taking, careful rating of each answer, and collecting confirmation for most answers, could easily move the needle on hiring decision power from the mid-thirties up to the high-fifties.

Finally, the gap between the potential value delivered by a staffing strategy is a function of decision power times funnel power. Funnel power is a direct function of the number of candidates evaluated at each decision point. If there is only one candidate per open position, funnel power=0. Hiring better talent when you have more candidates to choose from makes intuitive sense. The funnel power formula merely translates that common sense into numbers. The relationship between funnel power and number of candidates per decision point is complex mathematically, but well known. Some common values appear in the following Table 1:

TABLE 1

| Candidates/Decision | Funnel Power |
|---|---|
| 2 | 0.81 |
| 3 | 1.09 |
| 5 | 1.41 |
| 10 | 1.75 |
| 20 | 2.06 |
| 50 | 2.89 |
| 100 | 3.5 |

Putting the behavioral interview down at the end of the hiring funnel, where it applies to just three to five short list finalists, reduces the funnel power and thus the value of the staffing strategy. So if there was some feasible way to move the greater decision power of a behavioral interview up the hiring funnel, that could further leverage the value of a rigorous behavioral interviewing staffing strategy by from 30% to 150%.

Summing up, “How big is the gap between what is now, and what could be, for behavioral interviewing in the field?” we see a 20-30% gap in decision power and another 30% to 150% gap in staffing strategy funnel power.

To quantify how the gap between the potential and in-practice value of behavioral interviews matter to corporations, we examine four examples: (1) security guard, (2) collections agent, and (3) convenience store manager, and (4) department store manager. Another article in this series explores the science and the math behind the numbers that follow in the below Table 2.

TABLE 2

| | Top of | | Average | Per Hire Gap |
|---|---|---|---|---|
| Position | Funnel | Salary | Tenure | Impact in $ |
| Security Guard | 3 | $15,000 | 1.5 | $1,850 |
| Collections Agent | 8 | $24,000 | .75 | $3,100 |
| Convenience Store Mgr | 20 | $50,000 | 5 | $38,000 |
| Department Store Mgr | 150 | $70,000 | 16 | $214,000 |

The Top of Funnel column tabulates the number of people who respond with interest by: walking in, applying online at the corporate career site, calling in to an 800 number, faxing in their resume, or following up on an internal referral. Per Hire Gap Impact in $ column tabulates the increase in the performance value per hire that could be achieved for that position if behavioral interviewing were practiced to its full potential vs. practiced the way it normally plays out in field settings.

The gap impact in dollars varies so dramatically between security guard and department store manager for reasons that make good sense based on the well-established (and mathematically proven) utility formula. The dollar impact of hiring terrific vs. terrible security guards is not so high where the financial consequences of hiring a top vs. terrible department store manager could ruin the annual revenue forecast for that store. While hiring aggressive vs. mild mannered collections agents has considerably greater dollar impact than hiring mistakes for security guards, their shorter tenure cuts into the gap impact for them. For the convenience store chain, the store manager impacts not only the hiring of store staff, but more broadly, as the store manager also is empowered to adjust the store inventory to meet local retail conditions. Not only do convenience store managers have greater performance dollar impact and greater tenure, there are also many more candidates to choose from, and they stay at least 5 times as long as the first two positions in the table—thus the ten times increase in gap impact. The annual store revenue for the convenience stores runs around one million dollars but it is many times that for department store managers. On top of that, a strong employer brand attracts even more candidates for department store manager and they stay 16 years with the company on average. Financially, closing the gap for department store managers makes a lot of sense and quite a few dollars per hire—even though the department store chain collects those dollars over a 16 year period for each manager hired.

The above literature review and professional observations capture the gap between the potential value of behavioral interviewing done precisely as found in the “best practice” literature and the way it is practiced manually in the field by hiring managers. U.S. application 20150206103, expressly incorporated herein by reference in it entirety, presents an advance in the efficiency of conducting pre-employment screening interviews via video interview automation of the following elements of the interview process: (1) the presentation of interview questions, (2) the capture and storage of interview answers, and (3) the review and subjective evaluation of interview answers. These elements are present in a wide array of video interviewing systems offered over the internet. In addition to those elements, U.S. application 20150206103 goes further to present analytical processes and methods for extracting cues related to how candidates answer questions, including both audio and video cues extracted from the stored video record of the interview answer. The digital interview cues can be derived, identified, or generated from various sources of candidate data. The digital interview cues can be pre-interview cues from pre-interview sources, such as data from HTTP user agent data (e.g., browser, operating system (OS), or internet protocol (IP)), from resume parsing (e.g., education, GPA, internships, publications, etc.), from user interaction (UX)/user interface (UI) data, such as proper form filling, efficient behavior, like words per minute (WPM) and how quickly the candidate navigates the digital interviewing platform. The pre-interview data may also be third-party candidate data from online administered assessments, social media websites, blogs, or the like. For example, the pre-interview data can be obtained from the candidate's profiles on the LinkedIn, Facebook, GILD, Github, Instagram, Twitter or other third-party websites. The pre-interview data may also include user account data (e.g., email address, email host, or the like). The pre-interview data may also include candidate data from previous positions in the digital interviewing platform. For example, performance information from previous interviews by the candidate can be used to predict future performance by the candidate. In one embodiment, the cue generator collects timing data from a training data set and determines a time metric representative of the respective interviewing candidate's timeliness on starting and completing an interview, and/or determines whether the respective interviewing candidate missed a deadline or requested additional time to complete the interview. In another embodiment, the cue generator can inspect a log of user interactions to identify the user interaction cues.

In another embodiment, described in U.S. application 20150206103, the interviewing cues can be post-interview cues, such as timing data, audio data, video data, or the like. The timing data may include information about how timely the candidate was on starting the interview, completing the interview, or total interview duration. The timing data may also include information to indicate whether the candidate requested additional time due to a missed deadline or other timing information about time-sensitive parameters set for the interview. The cue generator can inspect an audio signal or audio samples of the candidate data to identify the audio cues for a candidate. In one embodiment, the cue generator includes an audio cue generator that collects audio data from the training data set (or current data) and identifies utterances in the audio signal of a digital interview by a candidate. An utterance is a group of one or more words spoken by a candidate in the digital interview. The audio cue generator generates the audio cues based on the identified utterances. In another embodiment, the audio generator can alternatively or additional generate audio cues based on gaps between the identified utterances. In another embodiment, the audio cue generator can analyze the raw audio data to determine summary statistics (e.g., maximum, minimum, median, skew, standard deviation, mode, slope, kurtosis, or the like) on the utterances, summary statistics on the gaps between utterances, utterance repetition metrics (e.g., condition of utterance power spectrum density (PSD) function), a frequency spectral analysis (e.g., performing Fast Fourier Transform (FFT) variants on the sound spectrum to generate frequency statistics), mood detection (e.g., aggression, distress, engagement, motivation, or nervousness), or the like. In another embodiment, the audio cue generator can generate audio cues based on voice-to-text data. For example, the voice-to-text data may include grammar scoring. In one embodiment, a Linux command line tool diction can determine the number of commonly misused phrases, double words, and grammar errors, and these numbers can be normalized by the number of sentences detected). The voice-to-text data may also include positive or negative sentiments that can be generated from text data where weights are given to each word, or tuple (groups) of words, to determine an overall mood of the text. Black list word clouds (racist terms, swearing, vulgarity), summary statistics on word length (e.g., character count or syllable count), summary statistics on word difficulty, and filler-word frequency can also be types of voice-to-text data that can be analyzed for digital interviewing cues. For example, a dictionary can be used to map a word with a difficulty rating to allow grammar depth to be tested.

The cue generators can inspect a video signal to identify the video cues for a candidate. In one embodiment, the cue generators include a specific video cue generator to identify the video cues based on the video data. In one embodiment, the video cue generator determines video metrics in video data of the digital interview by a candidate. The video cue generator generates the video cues based on the video metrics. The video metrics may include heart rate detection (e.g., using Eulerian video magnification), candidate facial expression (e.g., smiling, confusion, agitation), eye movement data, environment data (e.g., how cluttered in the background, how private is the environment), or candidate movement data (e.g., what temporal frequencies is the candidate moving in, what is the jitter frequency, or the like).

Behavioral Answer Coaching (BAC), described in 20150206103, involves providing candidates with immediate feedback and coaching following the answer recording, whether by literal characters typed into a web page text box, or as recorded on a microphone connected to the internet. The embodiment of BAC that takes place within the context of collecting literal characters via a web browser involves having the answer string scanned for specific words or phrases that signify the candidate has not described a personal contribution to an important outcome in specific behavioral detail. For example, if the following verb tenses appear in an answer—“will can are is should could would may might try tried” candidates are advised, following clicking the submit button, that they may wish to revise their answer to have it focus on specific past actions, since these words are often used by people describing a generality or their intended performance. In another instance the text string is scanned for length, and if under a specific number of characters, the candidate is advised that “while you may have just been highly concise, most effective answers consist of at least XXX characters. You may wish to expand your answer after reviewing the specific probing questions that appear just below the question itself.” The embodiment of BAC that occurs within the context of collecting answers via a microphone follows the same automated coaching process, but based on the text strings extracted via a voice-to-text SAAS service that delivers the text string to the analytics and coaching processes described above.

U.S. application 20150206103 identified two classes of predictive inputs to be included in the set of predictors to be tested in an analytics engine against job performance measures, in order to build a maximally predictive performance model of pre-employment data to be used towards identifying the most valuable future performers for a specific position opening from among those that had completed online video interviews. Those classes are: (1) information obtained either before or after a pre-employment online interview, and (2) cues arising from the stored audio and video files of candidates responding to interview questions presented on an internet-connected device such as a smart phone, tablet, or Personal Computer. The cues identified as Class 2 include a wide range of objectively measured characteristics of the answer that can be characterized as measures of HOW candidates answer interview questions. But a careful review of the scientific literature cited earlier on what cues best predict future talent value on the job finds that it is what candidates say—the content of their answers, when provided in response to questions that focus on what they did in specific, challenging situations—that produced outstanding results or that caused disappointing results. Top talent delivers more impressive and more frequent examples of outstanding performance, and describes critical lessons learned from disappointing results that are then applied in subsequent situations to overcome the challenges. None of this is captured directly by how the candidate answers the question. Even candidates with a mediocre or even poor record of achievements can be trained to respond to traditional interview questions with energy, enthusiasm, poise, and presence as called for by the cues given off by the interviewer. Thus, this is an area of human behavior where substance is more telling, and more predictive of desired future behavior, than form, yet the prior art focuses primarily on such stylistic elements.

The following references are expressly incorporated herein by reference in their entirety:

U.S. Pat. Nos. 3,892,053; 4,468,204; 4,508,510; 4,699,153; 4,735,572; 4,916,745; 5,066,016; 5,152,290; 5,178,149; 5,390,281; 5,682,882; 5,696,981; 5,717,825; 5,734,372; 5,754,938; 5,790,645; 5,907,597; 5,937,387; 5,954,581; 5,987,415; 5,995,590; 6,018,682; 6,030,226; 6,052,122; 6,058,367; 6,067,565; 6,091,826; 6,157,913; 6,159,015; 6,182,218; 6,188,777; 6,230,111; 6,233,545; 6,249,282; 6,259,889; 6,260,034; 6,269,275; 6,272,457; 6,272,467; 6,283,761; 6,287,196; 6,290,602; 6,314,412; 6,332,143; 6,338,051; 6,341,267; 6,346,879; 6,347,261; 6,389,415; 6,414,691; 6,418,435; 6,430,523; 6,480,826; 6,491,525; 6,497,577; 6,520,905; 6,573,917; 6,604,090; 6,606,581; 6,622,036; 6,622,140; 6,629,242; 6,648,649; 6,654,748; 6,655,963; 6,658,391; 6,714,917; 6,721,734; 6,724,887; 6,748,353; 6,782,510; 6,820,037; 6,863,534; 6,865,546; 6,874,127; 6,901,390; 6,910,129; 6,923,763; 6,928,392; 6,978,115; 6,996,520; 6,999,914; 7,058,566; 7,062,475; 7,064,554; 7,089,218; 7,092,926; 7,107,261; 7,137,070; 7,143,089; 7,149,704; 7,162,432; 7,188,358; 7,200,635; 7,207,804; 7,210,163; 7,212,985; 7,225,122; 7,346,492; 7,346,541; 7,383,283; 7,395,201; 7,444,403; 7,447,635; 7,464,040; 7,487,089; 7,490,048; 7,493,655; 7,496,553; 7,519,529; 7,519,562; 7,526,426; 7,593,854; 7,630,961; 7,644,060; 7,774,334; 7,792,258; 7,801,724; 7,805,431; 7,813,917; 7,822,783; 7,860,222; 7,860,873; 7,881,924; 7,881,933; 7,933,399; 7,980,931; 7,995,717; 8,010,546; 8,010,556; 8,051,013; 8,073,807; 8,078,453; 8,117,091; 8,145,474; 8,150,680; 8,159,504; 8,160,867; 8,185,646; 8,195,668; 8,321,202; 8,473,490; 8,495,503; 8,583,563; 8,651,961; 8,719,035; 8,775,162; 9,009,045; 9,227,140; 9,268,765; 9,269,273; 9,269,374; 20010042004; 20010049597; 20010049620; 20020029157; 20020042748; 20020045154; 20020046139; 20020111540; 20030018915; 20030131055; 20030144843; 20030149975; 20040019518; 20040076936; 20040111479; 20040234932; 20050053902; 20050097364; 20050177528; 20050192679; 20060069955; 20060173556; 20070073681; 20070167689; 20070178428; 20070198849; 20070288394; 20070299631; 20080059282; 20080081320; 20080140508; 20080249968; 20090119154; 20090140864; 20100076912; 20120185251.

Clustering

The field of data clustering based on semantic concepts is well developed. Typically, a data set that has structure of various types is processed statistically to yield classifications of the data or information within a data object.

Data clustering is a process of grouping together data points having common characteristics. In automated processes, a cost function or distance function is defined, and data is classified is belonging to various clusters by making decisions about its relationship to the various defined clusters (or automatically defined clusters) in accordance with the cost function or distance function. Therefore, the clustering problem is an automated decision-making problem. The science of clustering is well established, and various different paradigms are available. After the cost or distance function is defined and formulated as clustering criteria, the clustering process becomes one of optimization according to an optimization process, which itself may be imperfect or provide different optimized results in dependence on the particular optimization employed. For large data sets, a complete evaluation of a single optimum state may be infeasible, and therefore the optimization process is subject to error, bias, ambiguity, or other known misleading artifacts.

In some cases, the distribution of data is continuous, and the cluster boundaries are sensitive to subjective considerations or have particular sensitivity to the aspects and characteristics of the clustering technology employed. In contrast, in other cases, the inclusion of data within a particular cluster is relatively insensitive to the clustering methodology. Likewise, in some cases, the use of the clustering results focuses on the marginal data, that is, the quality of the clustering is a critical factor in the use of the system.

The ultimate goal of clustering is to provide users with meaningful insights from the original data, so that they can effectively solve the problems encountered. Clustering acts to effectively reduce the dimensionality of a data set by treating each cluster as a degree of freedom, with a distance from a centroid or other characteristic exemplar of the set. In a non-hybrid system, the distance is a scalar, while in systems that retain some flexibility at the cost of complexity, the distance itself may be a vector. Thus, a data set with 10,000 data points, potentially has 10,000 degrees of freedom, that is, each data point represents the centroid of its own cluster. However, if it is clustered into 100 groups of 100 data points, the degrees of freedom is reduced to 100, with the remaining differences expressed as a distance from the cluster definition. Cluster analysis groups data objects based on information in or about the data that describes the objects and their relationships. The goal is that the objects within a group be similar (or related) to one another and different from (or unrelated to) the objects in other groups. The greater the similarity (or homogeneity) within a group and the greater the difference between groups, the “better” or more distinct is the clustering.

In some cases, the dimensionality may be reduced to one, in which case all of the dimensional variety of the data set is reduced to a distance according to a distance function. This distance function may be useful, since it permits dimensionless comparison of the entire data set, and allows a user to modify the distance function to meet various constraints. Likewise, in certain types of clustering, the distance functions for each cluster may be defined independently, and then applied to the entire data set. In other types of clustering, the distance function is defined for the entire data set, and is not (or cannot readily be) tweaked for each cluster. Similarly, feasible clustering algorithms for large data sets preferably do not have interactive distance functions in which the distance function itself changes depending on the data. Many clustering processes are iterative, and as such produce a putative clustering of the data, and then seek to produce a better clustering, and when a better clustering is found, making that the putative clustering. However, in complex data sets, there are relationships between data points such that a cost or penalty (or reward) is incurred if data points are clustered in a certain way. Thus, while the clustering algorithm may split data points which have an affinity (or group together data points, which have a negative affinity, the optimization becomes more difficult.

Thus, for example, a semantic database may be represented as a set of documents with words or phrases. Words may be ambiguous, such as “apple”, representing a fruit, a computer company, a record company, and a musical artist. In order to use the database effectively, the multiple meanings or contexts need to be resolved. In order to resolve the context, an automated process might be used to exploit available information for separating the meanings, i.e., clustering documents according to their context. This automated process can be difficult as the data set grows, and in some cases the available information is insufficient for accurate automated clustering. On the other hand, a human can often determine a context by making an inference, which, though subject to error or bias, may represent a most useful result regardless.

In supervised classification, the mapping from a set of input data vectors to a finite set of discrete class labels is modeled in terms of some mathematical function including a vector of adjustable parameters. The values of these adjustable parameters are determined (optimized) by an inductive learning algorithm (also termed inducer), whose aim is to minimize an empirical risk function on a finite data set of input. When the inducer reaches convergence or terminates, an induced classifier is generated. In unsupervised classification, called clustering or exploratory data analysis, no labeled data are available. The goal of clustering is to separate a finite unlabeled data set into a finite and discrete set of “natural,” hidden data structures, rather than provide an accurate characterization of unobserved samples generated from the same probability distribution. In semi-supervised classification, a portion of the data are labeled, or sparse label feedback is used during the process.

While clustering of interviewing responses can be performing without intrinsic knowledge of the natural language under consideration, it would be expected to produce a higher degree of missed cues and false clusters than one based on a sophisticated intrinsic knowledge of that natural language, including morphology, grammar, syntax and semantics.

Non-predictive clustering is a subjective process in nature, seeking to ensure that the similarity between objects within a cluster is larger than the similarity between objects belonging to different clusters. Cluster analysis divides data into groups (clusters) that are meaningful, useful, or both. If meaningful groups are the goal, then the clusters should capture the “natural” structure of the data. In some cases, however, cluster analysis is only a useful starting point for other purposes, such as data summarization. However, this often begs the question, especially in marginal cases; what is the natural structure of the data, and how do we know when the clustering deviates from “truth”?

Many data analysis techniques, such as regression or principal component analysis (PCA), have a time or space complexity of O(m²) or higher (where m is the number of objects), and thus, are not practical for large data sets. However, instead of applying the algorithm to the entire data set, it can be applied to a reduced data set consisting only of cluster prototypes. Depending on the type of analysis, the number of prototypes, and the accuracy with which the prototypes represent the data, the results can be comparable to those that would have been obtained if all the data could have been used. The entire data set may then be assigned to the clusters based on a distance function.

Clustering algorithms partition data into a certain number of clusters (groups, subsets, or categories). Important considerations include feature selection or extraction (choosing distinguishing or important features, and only such features); Clustering algorithm design or selection (accuracy and precision with respect to the intended use of the classification result; feasibility and computational cost; etc.); and to the extent different from the clustering criterion, optimization algorithm design or selection.

Finding nearest neighbors can require computing the pairwise distance among all points. However, clusters and their cluster prototypes might be found more efficiently. Assuming that the clustering distance metric reasonably includes close points, and excludes far points, then the neighbor analysis may be limited to members of nearby clusters, thus reducing the complexity of the computation.

There are generally three types of clustering structures, known as partitional clustering, hierarchical clustering, and individual clustering. The most commonly discussed distinction among different types of clusterings is whether the set of clusters is nested or un-nested, or in more traditional terminology, hierarchical or partitional. A partitional clustering is simply a division of the set of data objects into non-overlapping subsets (clusters) such that each data object is in exactly one subset. If the clusters have sub-clusters, then we obtain a hierarchical clustering, which is a set of nested clusters that are organized as a tree. Each node (cluster) in the tree (except for the leaf nodes) is the union of its children (sub-clusters), and the root of the tree is the cluster containing all the objects. Often, but not always, the leaves of the tree are singleton clusters of individual data objects. A hierarchical clustering can be viewed as a sequence of partitional clusterings and a partitional clustering can be obtained by taking any member of that sequence; i.e., by cutting the hierarchical tree at a particular level.

There are many situations in which a point could reasonably be placed in more than one cluster, and these situations are better addressed by non-exclusive clustering. In the most general sense, an overlapping or non-exclusive clustering is used to reflect the fact that an object can simultaneously belong to more than one group (class). A non-exclusive clustering is also often used when, for example, an object is “between” two or more clusters and could reasonably be assigned to any of these clusters. In a fuzzy clustering, every object belongs to every cluster with a membership weight. In other words, clusters are treated as fuzzy sets. Similarly, probabilistic clustering techniques compute the probability with which each point belongs to each cluster.

In many cases, a fuzzy or probabilistic clustering is converted to an exclusive clustering by assigning each object to the cluster in which its membership weight or probability is highest. Thus, the inter-cluster and intra-cluster distance function is symmetric. However, it is also possible to apply a different function to uniquely assign objects to a particular cluster.

A well-separated cluster is a set of objects in which each object is closer (or more similar) to every other object in the cluster than to any object not in the cluster. Sometimes a threshold is used to specify that all the objects in a cluster must be sufficiently close (or similar) to one another. The distance between any two points in different groups is larger than the distance between any two points within a group. Well-separated clusters do not need to be spherical, but rather can have any shape.

If the data is represented as a graph, where the nodes are objects and the links represent connections among objects, then a cluster can be defined as a connected component; i.e., a group of objects that are significantly connected to one another, but that are less connected to objects outside the group. This implies that each object in a contiguity-based cluster is closer to some other object in the cluster than to any point in a different cluster.

A density-based cluster is a dense region of objects that is surrounded by a region of low density. A density-based definition of a cluster is often employed when the clusters are irregular or intertwined, and when noise and outliers are present. DBSCAN is a density-based clustering algorithm that produces a partitional clustering, in which the number of clusters is automatically determined by the algorithm. Points in low-density regions are classified as noise and omitted; thus, DBSCAN does not produce a complete clustering.

A prototype-based cluster is a set of objects in which each object is closer (more similar) to the prototype that defines the cluster than to the prototype of any other cluster. For data with continuous attributes, the prototype of a cluster is often a centroid, i.e., the average (mean) of all the points in the cluster. When a centroid is not meaningful, such as when the data has categorical attributes, the prototype is often a medoid, i.e., the most representative point of a cluster. For many types of data, the prototype can be regarded as the most central point. These clusters tend to be globular. K-means is a prototype-based, partitional clustering technique that attempts to find a user-specified number of clusters (K), which are represented by their centroids. Prototype-based clustering techniques create a one-level partitioning of the data objects. There are a number of such techniques, but two of the most prominent are K-means and K-medoid. K-means defines a prototype in terms of a centroid, which is usually the mean of a group of points, and is typically applied to objects in a continuous n-dimensional space. K-medoid defines a prototype in terms of a medoid, which is the most representative point for a group of points, and can be applied to a wide range of data since it requires only a proximity measure for a pair of objects. While a centroid almost never corresponds to an actual data point, a medoid, by its definition, must be an actual data point.

In the K-means clustering technique, we first choose K initial centroids, the number of clusters desired. Each point in the data set is then assigned to the closest centroid, and each collection of points assigned to a centroid is a cluster. The centroid of each cluster is then updated based on the points assigned to the cluster. We iteratively assign points and update until convergence (no point changes clusters), or equivalently, until the centroids remain the same. For some combinations of proximity functions and types of centroids, K-means always converges to a solution; i.e., K-means reaches a state in which no points are shifting from one cluster to another, and hence, the centroids don't change. Because convergence tends to b asymptotic, the end condition may be set as a maximum change between iterations. Because of the possibility that the optimization results in a local minimum instead of a global minimum, errors may be maintained unless and until corrected. Therefore, a human assignment or reassignment of data points into classes, either as a constraint on the optimization, or as an initial condition, is possible.

To assign a point to the closest centroid, a proximity measure is required. Euclidean (L2) distance is often used for data points in Euclidean space, while cosine similarity may be more appropriate for documents. However, there may be several types of proximity measures that are appropriate for a given type of data. For example, the Manhattan (L1) distance can be used for Euclidean data, while the Jaccard measure is often employed for documents. Usually, the similarity measures used for K-means are relatively simple since the algorithm repeatedly calculates the similarity of each point to each centroid, and thus complex distance functions incur computational complexity. The clustering may be computed as a statistical function, e.g., mean square error of the distance of each data point according to the distance function from the centroid. Note that the K-means may only find a local minimum, since the algorithm does not test each point for each possible centroid, and the starting presumptions may influence the outcome. The typical distance functions for documents include the Manhattan (L1) distance, Bregman divergence, the Mahalanobis distance, squared Euclidean distance and cosine similarity.

An optimal clustering will be obtained as long as two initial centroids fall anywhere in a pair of clusters, since the centroids will redistribute themselves, one to each cluster. As the number of clusters increases, it is increasingly likely that at least one pair of clusters will have only one initial centroid, and because the pairs of clusters are further apart than clusters within a pair, the K-means algorithm will not redistribute the centroids between pairs of clusters, leading to a suboptimal local minimum. One effective approach is to take a sample of points and cluster them using a hierarchical clustering technique. K clusters are extracted from the hierarchical clustering, and the centroids of those clusters are used as the initial centroids. This approach often works well, but it is practical only if the sample is relatively small, e.g., a few hundred to a few thousand (hierarchical clustering is expensive), and K is relatively small compared to the sample size. Other selection schemes are also available.

The space requirements for K-means are modest because only the data points and centroids are stored. Specifically, the storage required is O((m+K)ⁿ), where m is the number of points and n is the number of attributes. The time requirements for K-means are also modest-basically linear in the number of data points. In particular, the time required is O(I×K×m×n), where I is the number of iterations required for convergence. As mentioned, I is often small and can usually be safely bounded, as most changes typically occur in the first few iterations. Therefore, K-means is linear in m, the number of points, and is efficient as well as simple provided that K, the number of clusters, is significantly less than m.

Outliers can unduly influence the clusters, especially when a squared error criterion is used. However, in some clustering applications, the outliers should not be eliminated or discounted, as their appropriate inclusion may lead to important insights.

Hierarchical clustering techniques are a second important category of clustering methods. There are two basic approaches for generating a hierarchical clustering: Agglomerative and divisive. Agglomerative clustering merges close clusters in an initially high dimensionality space, while divisive splits large clusters. Agglomerative clustering relies upon a cluster distance, as opposed to an object distance. For example the distance between centroids or medioids of the clusters, the closest points in two clusters, the further points in two clusters, or some average distance metric. Ward's method measures the proximity between two clusters in terms of the increase in the sum of the squares of the errors that results from merging the two clusters.

Agglomerative Hierarchical Clustering refers to clustering techniques that produce a hierarchical clustering by starting with each point as a singleton cluster and then repeatedly merging the two closest clusters until a single, all-encompassing cluster remains. Agglomerative hierarchical clustering cannot be viewed as globally optimizing an objective function. Instead, agglomerative hierarchical clustering techniques use various criteria to decide locally, at each step, which clusters should be merged (or split for divisive approaches). This approach yields clustering algorithms that avoid the difficulty of attempting to solve a hard combinatorial optimization problem. Furthermore, such approaches do not have problems with local minima or difficulties in choosing initial points. Of course, the time complexity of O(m² log m) and the space complexity of O(m²) are prohibitive in many cases. Agglomerative hierarchical clustering algorithms tend to make good local decisions about combining two clusters since they can use information about the pair-wise similarity of all points. However, once a decision is made to merge two clusters, it cannot be undone at a later time. This approach prevents a local optimization criterion from becoming a global optimization criterion.

In supervised classification, the evaluation of the resulting classification model is an integral part of the process of developing a classification model. Being able to distinguish whether there is non-random structure in the data is an important aspect of cluster validation.

### BIBLIOGRAPHY

Each of the following references is expressly incorporated herein by reference in its entirety:
U.S. Pat. Nos. 4,081,607; 4,257,703; 4,773,093; 4,855,923; 4,965,580; 5,020,411; 5,253,307; 5,285,291; 5,327,521; 5,442,792; 5,448,684; 5,463,702; 5,497,486; 5,506,801; 5,566,078; 5,574,837; 5,625,704; 5,627,040; 5,668,897; 5,699,507; 5,710,916; 5,717,915; 5,724,571; 5,731,989; 5,748,780; 5,764,283; 5,795,727; 5,809,490; 5,813,002; 5,872,850; 5,889,523; 5,920,852; 5,926,820; 5,940,529; 5,940,833; 5,949,367; 6,041,311; 6,049,777; 6,085,151; 6,092,049; 6,100,825; 6,112,186; 6,121,969; 6,122,628; 6,140,643; 6,185,314; 6,192,364; 6,203,987; 6,249,241; 6,263,088; 6,263,334; 6,282,538; 6,295,367; 6,295,504; 6,295,514; 6,300,965; 6,331,859; 6,351,712; 6,373,485; 6,389,169; 6,400,831; 6,411,953; 6,415,046; 6,421,612; 6,424,971; 6,424,973; 6,437,796; 6,445,391; 6,453,246; 6,463,433; 6,466,695; 6,468,476; 6,470,094; 6,473,522; 6,484,168; 6,487,554; 6,496,834; 6,505,191; 6,519,591; 6,526,389; 6,535,881; 6,539,352; 6,556,983; 6,564,197; 6,584,220; 6,584,433; 6,592,627; 6,594,658; 6,615,205; 6,627,464; 6,636,849; 6,643,629; 6,674,905; 6,684,177; 6,700,115; 6,701,026; 6,711,585; 6,732,119; 6,735,336; 6,735,465; 6,750,859; 6,751,363; 6,751,614; 6,757,415; 6,760,701; 6,763,128; 6,772,170; 6,778,699; 6,778,981; 6,785,409; 6,785,419; 6,797,526; 6,799,175; 6,801,645; 6,801,859; 6,804,670; 6,807,306; 6,816,848; 6,819,793; 6,826,316; 6,832,162; 6,834,266; 6,834,278; 6,841,403; 6,845,377; 6,854,096; 6,895,267; 6,904,420; 6,906,719; 6,907,380; 6,912,547; 6,915,241; 6,950,752; 6,952,700; 6,954,756; 6,961,721; 6,968,342; 6,970,796; 6,976,016; 6,980,984; 6,993,186; 6,999,886; 7,010,520; 7,016,531; 7,031,844; 7,031,980; 7,035,431; 7,035,823; 7,039,446; 7,039,621; 7,043,463; 7,047,252; 7,054,724; 7,058,566; 7,058,638; 7,058,650; 7,062,083; 7,065,521; 7,065,587; 7,068,723; 7,111,188; 7,113,958; 7,139,739; 7,142,602; 7,158,970; 7,167,578; 7,174,048; 7,177,470; 7,188,055; 7,196,705; 7,202,791; 7,206,778; 7,215,786; 7,216,129; 7,221,794; 7,222,126; 7,225,397; 7,231,074; 7,246,012; 7,246,128; 7,251,648; 7,263,220; 7,272,262; 7,275,018; 7,287,019; 7,287,064; 7,293,036; 7,296,011; 7,296,088; 7,325,201; 7,328,363; 7,337,158; 7,346,492; 7,346,601; 7,369,680; 7,369,889; 7,369,961; 7,376,752; 7,386,426; 7,389,281; 7,395,250; 7,397,946; 7,401,087; 7,406,200; 7,418,136; 7,424,462; 7,426,301; 7,428,528; 7,428,541; 7,437,308; 7,450,122; 7,450,746; 7,458,050; 7,461,073; 7,464,074; 7,468,730; 7,475,085; 7,487,056; 7,492,943; 7,499,916; 7,512,524; 7,516,149; 7,519,209; 7,519,227; 7,526,101; 7,526,426; 7,529,732; 7,539,656; 7,545,978; 7,552,131; 7,552,474; 7,555,441; 7,558,425; 7,562,015; 7,562,325; 7,565,213; 7,565,251; 7,565,346; 7,565,432; 7,567,961; 7,570,213; 7,574,069; 7,574,409; 7,580,556; 7,580,682; 7,584,168; 7,590,264; 7,599,799; 7,599,917; 7,603,326; 7,610,306; 7,613,572; 7,624,337; 7,639,714; 7,639,868; 7,643,597; 7,644,090; 7,650,320; 7,657,100; 7,657,126; 7,657,379; 7,660,468; 7,679,617; 7,684,963; 7,685,090; 7,688,495; 7,689,457; 7,693,683; 7,697,785; 7,702,155; 7,702,660; 7,707,210; 7,711,846; 7,716,148; 7,736,905; 7,739,284; 7,743,058; 7,743,059; 7,746,534; 7,747,054; 7,747,390; 7,747,547; 7,752,208; 7,757,116; 7,761,448; 7,767,395; 7,769,626; 7,773,784; 7,783,249; 7,797,180; 7,801,685; 7,801,724; 7,801,893; 7,805,266; 7,805,443; 7,805,496; 7,813,580; 7,813,917; 7,814,040; 7,822,426; 7,823,055; 7,826,635; 7,827,181; 7,827,183; 7,831,325; 7,831,531; 7,831,549; 7,835,542; 7,842,874; 7,848,567; 7,849,027; 7,853,445; 7,856,434; 7,865,456; 7,868,786; 7,873,616; 7,874,841; 7,876,947; 7,879,620; 7,882,119; 7,882,126; 7,885,966; 7,889,679; 7,889,914; 7,890,294; 7,890,510; 7,890,512; 7,894,669; 7,894,995; 7,899,564; 7,904,303; 7,912,284; 7,912,290; 7,912,726; 7,912,734; 7,917,306; 7,917,517; 7,926,026; 7,930,189; 7,933,740; 7,933,915; 7,937,234; 7,937,349; 7,949,186; 7,953,679; 7,953,705; 7,954,090; 7,958,096; 7,962,651; 7,966,130; 7,966,225; 7,966,327; 7,970,627; 7,975,035; 7,975,039; 7,979,362; 7,979,435; 7,991,557; 7,996,369; 8,000,527; 8,000,533; 8,005,294; 8,010,466; 8,010,589; 8,014,591; 8,014,957; 8,015,124; 8,015,125; 8,015,183; 8,019,766; 8,027,977; 8,032,476; 8,041,715; 8,046,362; 8,051,082; 8,051,139; 8,055,677; 8,065,248; 8,065,316; 8,073,652; 8,077,984; 8,078,453; 8,082,246; 8,090,729; 8,095,389; 8,095,521; 8,095,830; 8,097,469; 8,099,381; 8,108,392; 8,108,405; 8,108,931; 8,116,566; 8,117,139; 8,117,203; 8,117,204; 8,117,213; 8,122,045; 8,122,502; 8,135,679; 8,135,680; 8,135,681; 8,135,719; 8,139,838; 8,145,669; 8,150,169; 8,150,680; 8,160,867; 8,164,507; 8,165,406; 8,165,407; 8,169,481; 8,169,681; 8,170,306; 8,170,961; 8,175,412; 8,175,730; 8,175,896; 8,180,147; 8,180,627; 8,180,766; 8,183,050; 8,184,913; 8,185,481; 8,190,082; 8,190,663; 8,191,783; 8,195,345; 8,195,670; 8,195,734; 8,200,506; 8,200,648; 8,204,842; 8,219,435; 8,226,418; 8,285,719; 8,301,482; 8,305,930; 8,321,202; 8,407,055; 8,449,300; 8,463,053; 8,499,022; 8,527,432; 8,655,804; 8,676,805; 8,700,547; 8,775,162; 8,843,490; 8,868,408; 8,887,286; 8,923,630; 8,996,528; 9,230,216; 9,280,562; 9,311,467; 9,336,302; 9,355,092; 9,372,915; 20010000356; 20010014868; 20010048753; 20010055019; 20020000986; 20020002550; 20020002555; 20020023061; 20020033835; 20020049740; 20020050990; 20020069218; 20020091655; 20020099675; 20020099721; 20020111966; 20020115070; 20020122587; 20020128781; 20020129038; 20020131641; 20020132479; 20020143989; 20020146175; 20020147703; 20020181711; 20020181786; 20020183966; 20020184080; 20020190198; 20020191034; 20030009333; 20030009469; 20030014191; 20030016250; 20030028564; 20030033138; 20030036093; 20030044053; 20030044062; 20030046018; 20030046253; 20030050908; 20030050923; 20030054573; 20030058339; 20030059081; 20030061249; 20030065635; 20030065661; 20030074251; 20030078494; 20030078509; 20030088563; 20030093227; 20030097356; 20030097357; 20030100996; 20030101003; 20030107768; 20030120630; 20030129660; 20030138978; 20030139851; 20030145014; 20030158842; 20030161396; 20030161500; 20030174179; 20030175720; 20030205124; 20030208488; 20030212546; 20030229635; 20040002954; 20040002973; 20040003005; 20040013292; 20040019574; 20040024739; 20040024758; 20040024773; 20040036716; 20040048264; 20040049517; 20040056778; 20040068332; 20040071368; 20040075656; 20040091933; 20040101198; 20040103377; 20040107205; 20040122797; 20040127777; 20040129199; 20040130546; 20040139067; 20040162647; 20040162834; 20040170318; 20040171063; 20040172225; 20040175700; 20040177069; 20040181527; 20040213461; 20040230586; 20040233987; 20040243362; 20040249789; 20040249939; 20040254901; 20040260694; 20040267774; 20050010571; 20050015376; 20050027829; 20050058336; 20050075995; 20050085436; 20050102272; 20050102305; 20050114331; 20050120105; 20050130215; 20050130230; 20050132069; 20050137806; 20050138056; 20050147303; 20050149269; 20050163373; 20050163384; 20050164273; 20050175244; 20050176057; 20050180638; 20050182570; 20050185848; 20050192768; 20050193216; 20050198575; 20050225678; 20050251882; 20050255458; 20050256413; 20050262044; 20050265331; 20050267991; 20050267992; 20050267993; 20050273319; 20050278324; 20050281291; 20050283328; 20050285937; 20050286774; 20060013482; 20060015341; 20060015630; 20060020662; 20060026152; 20060031219; 20060034545; 20060041414; 20060052943; 20060053129; 20060053142; 20060058592; 20060064177; 20060074621; 20060074771; 20060074924; 20060093188; 20060093208; 20060095251; 20060095521; 20060101060; 20060101377; 20060106816; 20060112146; 20060136589; 20060177837; 20060190191; 20060190465; 20060195204; 20060195269; 20060195415; 20060208185; 20060212337; 20060224356; 20060239338; 20060246495; 20060248141; 20060253258; 20060281473; 20060282298; 20060282425; 20070003138; 20070005556; 20070006177; 20070008905; 20070022279; 20070025637; 20070033170; 20070033214; 20070033221; 20070033292; 20070033515; 20070033521; 20070033533; 20070038612; 20070044010; 20070050708; 20070054266; 20070064627; 20070067212; 20070078846; 20070092888; 20070092905; 20070093966; 20070106405; 20070111316; 20070112758; 20070128573; 20070129011; 20070129991; 20070141527; 20070150443; 20070154066; 20070154931; 20070156516; 20070172803; 20070174267; 20070174335; 20070179784; 20070180980; 20070185946; 20070192034; 20070192063; 20070198553; 20070217676; 20070231921; 20070233711; 20070239694; 20070239741; 20070239982; 20070244768; 20070250522; 20070255707; 20070263900; 20070269804; 20070275108; 20070276723; 20070285575; 20070286489; 20070288465; 20070291958; 20080005137; 20080010045; 20080010262; 20080010272; 20080010273; 20080010605; 20080030836; 20080033658; 20080037536; 20080037872; 20080057590; 20080069437; 20080077570; 20080082426; 20080091423; 20080097820; 20080101705; 20080109214; 20080109288; 20080112684; 20080114564; 20080114710; 20080114756; 20080114800; 20080123940; 20080126464; 20080133221; 20080144943; 20080146334; 20080147438; 20080147440; 20080147441; 20080147591; 20080147655; 20080152231; 20080155335; 20080162541; 20080177538; 20080177640; 20080181479; 20080182282; 20080183546; 20080188964; 20080189306; 20080191035; 20080198160; 20080198231; 20080201397; 20080208828; 20080208855; 20080212899; 20080215510; 20080221876; 20080222075; 20080222225; 20080226151; 20080232687; 20080234977; 20080243637; 20080243638; 20080243815; 20080243816; 20080243817; 20080243839; 20080249414; 20080256093; 20080260247; 20080261516; 20080261820; 20080263088; 20080267471; 20080270121; 20080275671; 20080300797; 20080300875; 20080302657; 20080310005; 20080319973; 20090006378; 20090010495; 20090012766; 20090022374; 20090022472; 20090024555; 20090028441; 20090043714; 20090048841; 20090055147; 20090055257; 20090060042; 20090063537; 20090070346; 20090077093; 20090080777; 20090081645; 20090083211; 20090093717; 20090094020; 20090094021; 20090094207; 20090094208; 20090094209; 20090094231; 20090094232; 20090094233; 20090094265; 20090097728; 20090104605; 20090124512; 20090125482; 20090125916; 20090132347; 20090150340; 20090154795; 20090157389; 20090164192; 20090169065; 20090175544; 20090175545; 20090190798; 20090199099; 20090204333; 20090204574; 20090204609; 20090220488; 20090222430; 20090226081; 20090234876; 20090248399; 20090252046; 20090265024; 20090271246; 20090271359; 20090271363; 20090271397; 20090271404; 20090271405; 20090271424; 20090271694; 20090276705; 20090277322; 20090287682; 20090287689; 20090290778; 20090292482; 20090292694; 20090292695; 20090292802; 20090297048; 20090299705; 20090299822; 20090299990; 20090311786; 20090313294; 20090318815; 20090319454; 20090319526; 20090326383; 20090327185; 20100004898; 20100004923; 20100005105; 20100017487; 20100033182; 20100034422; 20100036647; 20100042563; 20100049431; 20100050260; 20100054278; 20100055678; 20100057391; 20100057399; 20100057534; 20100067745; 20100076981; 20100080439; 20100081661; 20100082367; 20100082614; 20100085358; 20100100515; 20100106713; 20100111370; 20100111396; 20100112234; 20100114928; 20100114929; 20100117978; 20100121638; 20100125594; 20100135582; 20100135597; 20100136553; 20100138894; 20100149917; 20100150453; 20100157089; 20100157340; 20100161232; 20100161590; 20100166339; 20100169025; 20100174492; 20100174732; 20100174976; 20100174977; 20100174978; 20100174979; 20100174980; 20100174982; 20100174983; 20100174985; 20100183555; 20100189333; 20100191532; 20100191722; 20100198864; 20100199186; 20100204061; 20100205213; 20100215903; 20100216660; 20100217763; 20100221722; 20100228625; 20100228731; 20100232718; 20100239147; 20100250477; 20100250527; 20100254614; 20100257092; 20100268476; 20100268512; 20100278425; 20100280987; 20100284915; 20100296748; 20100299128; 20100305868; 20100305930; 20100313157; 20100318492; 20100322525; 20100332210; 20100332242; 20100332425; 20100332474; 20100332475; 20110002028; 20110002194; 20110004115; 20110004415; 20110004578; 20110008805; 20110013840; 20110015869; 20110020779; 20110022354; 20110022599; 20110029657; 20110040192; 20110047172; 20110048731; 20110052076; 20110055192; 20110060716; 20110060717; 20110078143; 20110078144; 20110080490; 20110081056; 20110081066; 20110086349; 20110091073; 20110091074; 20110091083; 20110093482; 20110093492; 20110097001; 20110103613; 20110105340; 20110105350; 20110106801; 20110115787; 20110116690; 20110119048; 20110119108; 20110124525; 20110142287; 20110142318; 20110143650; 20110144480; 20110144914; 20110161205; 20110166949; 20110172501; 20110173173; 20110173189; 20110175905; 20110178965; 20110179019; 20110185234; 20110191076; 20110191283; 20110191353; 20110202540; 20110205399; 20110206246; 20110218990; 20110221767; 20110225158; 20110231350; 20110231414; 20110246200; 20110246409; 20110246483; 20110249811; 20110251081; 20110255747; 20110255748; 20110261049; 20110264432; 20110269479; 20110282828; 20110282877; 20110288890; 20110295773; 20110299765; 20110301860; 20110304619; 20110306354; 20110320396; 20120005238; 20120011135; 20120014560; 20120015841; 20120021710; 20120030165; 20120030185; 20120036096; 20120039541; 20120041955; 20120045119; 20120047098; 20120054133; 20120070452; 20120072124; 20120076372; 20120078858; 20120078906; 20120078927; 20120084251; 20120084283; 20120088981; 20120089341; 20120109778; 20120123279; 20120125178; 20120131701; 20120136860; 20120137182; 20120203545; 20140095418; 20150006153; 20150363385; 20160133274;
M. S. Aldenderfer and R. K. Blashfield. Cluster Analysis. Sage Publications, Los Angeles, 1985. M. R. Anderberg. Cluster Analysis for Applications. Academic Press, New York, December 1973. M. Ankerst, M. M. Breunig, H.-P. Kriegel, and J. Sander. OPTICS: Ordering Points To Identify the Clustering Structure. In Proc. of 1999 ACM-SIGMOD Intl. Conf. on Management of Data, pages 49-60, Philadelphia, Pa., June 1999. ACM Press. P. Arabie, L. Hubert, and G. D. Soete. An overview of combinatorial data analysis. In P. Arabie, L. Hubert, and G. D. Soete, editors, Clustering and Classification, pages 188-217. World Scientific, Singapore, January 1996. G. Ball and D. Hall. A Clustering Technique for Summarizing Multivariate Data. Behavior Science, 12:153-155, March 1967. A. Banerjee, S. Merugu, I. S. Dhillon, and J. Ghosh. Clustering with Bregman Divergences. In Proc. of the 2004 SIAM Intl. Conf. on Data Mining, pages 234-245, Lake Buena Vista, Fla., April 2004. P. Berkhin. Survey Of Clustering Data Mining Techniques. Technical report, Accrue Software, San Jose, Calif., 2002. D. Boley. Principal Direction Divisive Partitioning. Data Mining and Knowledge Discovery, 2(4):325-344, 1998. P. S. Bradley and U. M. Fayyad. Refining Initial Points for K-Means Clustering. In Proc. of the 15th Intl. Conf. on Machine Learning, pages 91-99, Madison, Wis., July 1998. Morgan Kaufmann Publishers Inc. CLUTO 2.1.1: Software for Clustering High-Dimensional Datasets. www.cs.umn.edu/.about.karypis, November 2003. I. S. Dhillon, Y. Guan, and J. Kogan. Iterative Clustering of High Dimensional Text Data Augmented by Local Search. In Proc. of the 2002 IEEE Intl. Conf. on Data Mining, pages 131-138. IEEE Computer Society, 2002. I. S. Dhillon and D. S. Modha. Concept Decompositions for Large Sparse Text Data Using Clustering. Machine Learning, 42(1/2):143-175, 2001. R. O. Duda, P. E. Hart, and D. G. Stork. Pattern Classification. John Wiley & Sons, Inc., New York, second edition, 2001. M. Ester, H.-P. Kriegel, J. Sander, M. Wimmer, and X. Xu. Incremental Clustering for Mining in a Data Warehousing Environment. In Proc. of the 24th VLDB Conf., pages 323-333, New York City, August 1998. Morgan Kaufmann. M. Ester, H.-P. Kriegel, J. Sander, and X. Xu. A Density-Based Algorithm for Discovering Clusters in Large Spatial Databases with Noise. In Proc. of the 2nd Intl. Conf. on Knowledge Discovery and Data Mining, pages 226-231, Portland, Oreg., August 1996. AAAI Press. B. S. Everitt, S. Landau, and M. Leese. Cluster Analysis. Arnold Publishers, London, fourth edition, May 2001. D. Fisher. Iterative Optimization and Simplification of Hierarchical Clusterings. Journal of Artificial Intelligence Research, 4:147-179, 1996. M. Halkidi, Y. Batistakis, and M. Vazirgiannis. Cluster validity methods: part I. SIGMOD Record (ACM Special Interest Group on Management of Data), 31(2):40-45, June 2002. M. Halkidi, Y. Batistakis, and M. Vazirgiannis. Clustering validity checking methods: part II. SIGMOD Record (ACM Special Interest Group on Management of Data), 31 (3):19-27, September 2002. G. Hamerly and C. Elkan. Alternatives to the k-means algorithm that find better clusterings. In Proc. of the 11th Intl. Conf. on Information and Knowledge Management, pages 600-607, McLean, Va., 2002. ACM Press. J. Han, M. Kamber, and A. Tung. Spatial Clustering Methods in Data Mining: A review. In H. J. Miller and J. Han, editors, Geographic Data Mining and Knowledge Discovery, pages 188-217. Taylor and Francis, London, December 2001. J. Hartigan. Clustering Algorithms. Wiley, New York, 1975. T. Hastie, R. Tibshirani, and J. H. Friedman. The Elements of Statistical Learning: Data Mining, Inference, Prediction. Springer, New York, 2001. A. K. Jain and R. C. Dubes. Algorithms for Clustering Data. Prentice Hall Advanced Reference Series. Prentice Hall, March 1988. www.cse.msu.edu/.about.jain/Clustering Jain Dubes.pdf. A. K. Jain, M. N. Murty, and P. J. Flynn. Data clustering: A review. ACM Computing Surveys, 31(3):264-323, September 1999. N. Jardine and R. Sibson. Mathematical Taxonomy. Wiley, New York, 1971. G. Karypis, E.-H. Han, and V. Kumar. Multilevel Refinement for Hierarchical Clustering. Technical Report TR 99-020, University of Minnesota, Minneapolis, Minn., 1999. L. Kaufman and P. J. Rousseeuw. Finding Groups in Data: An Introduction to Cluster Analysis. Wiley Series in Probability and Statistics. John Wiley and Sons, New York, November 1990. J. M. Kleinberg. An Impossibility Theorem for Clustering. In Proc. of the 16th Annual Conf. on Neural Information Processing Systems, Dec. 9-14, 2002. B. Larsen and C. Aone. Fast and Effective Text Mining Using Linear-Time Document Clustering. In Proc. of the 5th Intl. Conf. on Knowledge Discovery and Data Mining, pages 16-22, San Diego, Calif., 1999. ACM Press. J. MacQueen. Some methods for classification and analysis of multivariate observations. In Proc. of the 5th Berkeley Symp. on Mathematical Statistics and Probability, pages 281-297. University of California Press, 1967. G. W. Milligan. Clustering Validation: Results and Implications for Applied Analyses. In P. Arabie, L. Hubert, and G. D. Soete, editors, Clustering and Classification, pages 345-375. World Scientific, Singapore, January 1996. B. Mirkin. Mathematical Classification and Clustering, volume 11 of Nonconvex Optimization and Its Applications. Kluwer Academic Publishers, August 1996. T. Mitchell. Machine Learning. McGraw-Hill, Boston, Mass., 1997. F. Murtagh. Multidimensional Clustering Algorithms. Physica-Verlag, Heidelberg and Vienna, 1985. D. Pelleg and A. W. Moore. X-means: Extending K-means with Efficient Estimation of the Number of Clusters. In Proc. of the 17th Intl. Conf. on Machine Learning, pages 727-734. Morgan Kaufmann, San Francisco, Calif., 2000. C. Romesburg. Cluster Analysis for Researchers. Life Time Learning, Belmont, C A, 1984. J. Sander, M. Ester, H.-P. Kriegel, and X. Xu. Density-Based Clustering in Spatial Databases: The Algorithm GDBSCAN and its Applications. Data Mining and Knowledge Discovery, 2(2):169-194, 1998. S. M. Savaresi and D. Boley. A comparative analysis on the bisecting K-means and the PDDP clustering algorithms. Intelligent Data Analysis, 8(4):345-362, 2004. P. H. A. Sneath and R. R. Sokal. Numerical Taxonomy. Freeman, San Francisco, 1971. H. Spath. Cluster Analysis Algorithms for Data Reduction and Classification of Objects, volume 4 of Computers and Their Application. Ellis Horwood Publishers, Chichester, 1980. ISBN 0-85312-141-9. M. Steinbach, G. Karypis, and V. Kumar. A Comparison of Document Clustering Techniques. In Proc. of KDD Workshop on Text Mining, Proc. of the 6th Intl. Conf. on Knowledge Discovery and Data Mining, Boston, Mass., August 2000. C. T. Zahn. Graph-Theoretical Methods for Detecting and Describing Gestalt Clusters. IEEE Transactions on Computers, C-20(1):68-86, January 1971. B. Zhang, M. Hsu, and U. Dayal. K-Harmonic Means—A Data Clustering Algorithm. Technical Report HPL-1999-124, Hewlett Packard Laboratories, Oct. 29, 1999. Y. Zhao and G. Karypis. Empirical and theoretical comparisons of selected criterion functions for document clustering. Machine Learning, 55(3):311-331, 2004. Anderberg, M. R. (1973). Cluster Analysis for Applications. Academic Press, New York. Anderson, E. (1957). A semi-graphical method for the analysis of complex problems. Proc. Nat. Acad. Sci. USA 43923-927. Anderson, T. W. (1958). An Introduction to Multivariate Statistical Analysis. Wiley, New York. Anderson, T. W., and Bahadur, R. R. (1962). classification into two multivariate normal distributions with different covariance matrices. Ann. Math. Statist. 33420-431. Andrews, D. F. (1972). Plots of high-dimensional data. Biometrics 28 125-136. Arabie, P. (1977). clustering representations of group overlap. J. Math. Soc. 5 112-128. Arabie, P. and Carroll, J. D. (1980). MAPCLUS: A mathematical programming approach to fitting to ADCLUS model. Psychometrika 45211-235. Art, D., Gnanadesikan, R., and Kettenring, J. R. (1982). Data-based metrics for cluster analysis. Utilitas Mathematica 31A 75-99. Asimov, D. (1985). The grand tour. SLAM J. Sci. Statist. Corn-put. 6 128-143. Baker, F. B. (1974). Stability of two hierarchical grouping techniques, Case I: Sensitivity to data errors. J. Amer. Statist. Assoc. 69440-445. Becker, P. (1968). Recognitions of Patterns. Polyteknisk, Copenhagen. Bell, P. A. and Korey, J. L. (1975). QUICLSTR: A FOR 'TRAN program for hierarchical cluster analysis with a large number of subjects. Behavioral Research Methods and Instrumentation 7575. Binder, D. A. (1978). Comment on ‘Estimating mixtures of normal distributions and switching regressions’. j Amer. Statist. Assoc. 73746-747. Blashfield, R. K., Aldenderfer, M. S. and Morey, L. C. (1982). cluster analysis literature on validation. In Classifying Social Data. (H. Hudson, ed.) 167-176. Jossey-Bass, San Francisco. Bock, H. H. (1985). On significance tests in cluster analysis. J. Classification 277-108. Brieman, L., Friedman, J. H., Olshen, R. A., and Stone, C. J. (1984). Classification and Regression Trees. Wadsworth, Belmont, Calif. Breiman, L. Meisel, W. S., and Purcell, E. (1977). Variable kernel estimates of multivariate densities and their calibration. Technometrics 19 135-144. Broadbent, S. R. and Hammersley, J. M. (1957). Percolation Processes, I: Crystals and Mazes. Proc. Cambridge Philos. Soc. 53629-641 Buja, A., Hurify, C. and Mcdonald, J. A. (1986). A data viewer for multivariate data. Computer Science and Statistics: Proceedings of the 18th Symposium on the Interface 171-174. Cacoullos, T. (1966). Estimation of a multivariate density. Ann. Math. Statist. 18 179-189. Chen, H., Gnanadesikan, R., and Kettenring, J. R. (1974). Statistical methods for grouping corporations. Sankhya B 36 1-28. Chernoff, H. (1972). The selection of effective attributes for deciding between hypotheses using linear discriminant functions. In Frontiers of Pattern Recognition. (S. Watanabe, ed.) 55-60. Academic Press, New York. Chernoff, H. (1973a). Some measures for discriminating between normal multivariate distributions with unequal covariance matrices. In Multivariate Analysis Ill. (P. R. Krishnaiah, ed.) 337-344. Academic Press, New York. Chernoff, H. (1973b). The use of faces to represent points in k-dimensional space graphically. J Amer. Statist. Assoc. 68 361-368. Clunies-Ross, C. W. and Riffenburgh, R. H. (1960). Geometry and linear discrimination. Biometrika 47185-189. Cormack, R. M. (1971). A review of classification (with discussion). J. Roy. Statist. Soc. A 134321-367. Cornfield, J. (1962). Joint dependence of rish of coronary heart disease on serum cholesterol and systolic blood pressure: a discriminant function analysis. Federal Proceedings 21 58-61. Cover, T. M. (1968). Estimation by the nearest neighbor rule. IEEE Transactions Information Theory IT-14 50-55. Cover, T. M. and Hart, P. E. (1967). Nearest neighbor pattern classification. IEEE Transactions, Information Theory IT-13 21-27. Dallal, G. E. (1975) A user's guide to J. A. Hartigan's clustering algorithms. (unpublished manuscript) Yale University. Day, N. E. (1969). Estimating the components of a mixture of normal distributions. Biometrika 56463-474. DAY, N. E., and KERRIDGE, D. F., (1967). A general maximum likelihood discriminant. Biometrics 23313-323. 94 Defays, D. (1977). An efficient algorithm for a complete link method. Computer Journal 20364-366. Dick, N. P. and Bowden, D. C. (1973). Maximum likelihood estimation for mixtures of two normal distributions. Biometrics 29781-790 Dixon, W. J. (ed.) (1981). BMDP Statistical Software. University of California Press, Berkeley. Donoho, A. W., Donoho, D. L. and Gasko, M. (1985). MacS-pin graphical data analysis software. D2 Software, Austin. Duda, R. O. and Hart, P. E. (1973). Pattern Classification and Scene Analysis. Wiley, New York. Edmonston, B. (1985). MICRO-CLUSTER: Cluster analysis software for microcomputers. Journal of Classification 2 127-130. Efron, B. (1975). The efficiency of logistic regression compared to normal discriminant analysis. j Amer. Statist. Assoc. 70 892-898. Efron, B. (1979). Bootstrap methods: Another look at the jack-knife. Ann. Statist. 7 1-26. Efron, B. (1982). The Jackknife, The Bootstrap, and Other Resampling Plans, SIAM NSF-CBMS, Monograph #38. Efron, B. (1983). Estimating the error rate of a prediction rule: Improvements on cross-validation. J. Amer. Statist. Assoc. 78 316-331. Everitt, B. (1980). Cluster Analysis. 2nd ed. Halsted, N.Y. Everitt, B. S. and Hand, D. J. (1981). Finite Mixture Distributions. Chapman and Hall, London. Farver, T. B. and Dunn, 0. J. (1979). Stepwise variable selection in classification problems. Biom. J. 21 145-153. Fisher, R. A. (1936). The use of multiple measurements in taxonomic problems. Ann. Eugenics 7(part 2) 179-188. Fisherkeller, M. A., Friedman, J. H., and Tukey, J. W. (1974). Prim-9: An interactive multidimensional data display and analysis system. SLAC-Pub. 1408, Stanford Linear Accelerator Center, Stanford, Calif. Fitch, W. M. and Marcouash, E. (1967). Construction of phylogenetic trees. Science 155279-284. Fix, E. and Hodges, J. (1951). Discriminatory analysis, non-parametric discrimination: consistency properties. Technical Report. Randolph Field, Tex.: USAF School of Aviation Medicine. Fowixes, E. B. (1987). Some diagnostics for binary logistic regression via smoothing. Biometrika to appear. Fowlkes, E. B., Gnanadesikan, R. and Kettenring, J. R. (1987). Variable selection in clustering and other contexts. In Design, Data, and Analysis, by Some Friends of Cuthbert Daniel (C. L. Mallows, ed.). Wiley, New York, to appear. Fowlkes, E. B. and Mallows, C. L. (1983). A method for comparing two hierarchical clusterings (with discussion). J Amer. Statist. Assoc. 78553-583. FRIEDMAN, H. P. and RUBIN, J. (1967). On some invariant criteria for grouping data. Journal of American Statistical Association 62 1159-1178. Friedman, J. H. and Tukey, J. W. (1974). A projection pursuit algorithm for exploratory data analysis. IEEE Trans. Comput. C-23 881-889. Gnanadesikan, R. (1977). Methods for Statistical Data Analysis of Multivariate Observations. Wiley, New York. Gnanadesikan, R. and Kettenring, J. R. (1984). A pragmatic review of multivariate methods in applications. In Statistics: An Appraisal. (H. A. David and H. T. David, eds.). Gnanadesikan, R., Kettenring, J. R., and Landwehr, J. M. (1977). Interpreting and assessing the results of cluster analyses. Bull Int. Statis. Inst. 47451-463. Gnanadesikan, R., Kettenring, J. R. and Landwehr, J. M. (1982). Projection plots for displaying clusters. In Statistics and Probability: Essays in Honor of C. R. Rao. (G. Kallianpur, P. R. Krishnaiah and J. K. Ghosh, eds.) 281-294. North-Holland, Amsterdam. Goldman, L., Weinberg, M., Weisberg, M., Olshen, R., Cook, F., Sargent, R. K., Lamas, G. A., Dennis, C., Deckelbam, L., Fineberg, H., Stiratelu, R. and the Medical Housestaffs At Yale-New Haven Hospital and Brigham and Women's Hospital (1982). A computer-derived protocol to aid in the diagnosis of emergency room patients with acute chest pain. The New England Journal of Medicine 307588-596. Gong, G. (1982). Cross-validation, the jackknife, and the bootstrap: excess error estimation in forward logistic regression. Ph.D. dissertation. Stanford University Technical Report No. 80. Department of Statistics. Gordon, L. and Olshen, R. A. (1978). Asymptotically efficient solutions to the classification problem. Ann. Statist. 6 515-533. Gordon, L. and Olshen, R. A. (1980). Consistent non-parametric regression from recursive partitioning schemes. J. Mult. Anal. 10 611-627. Gordon, L. and Olshen, R. A. (1984). Almost surely consistent nonparametric regression from recursive partitioning schemes. J. Mult. Anal. 15 147-163. Gower, J. C. and Ross, G. J. S. (1969). Minimum spanning trees and single linkage cluster analysis. Appl. Statist. 18 54-65. Gray, J. B. and Ling, R. F. (1984). K-clustering as a detection tool for influential subsets regression (with discussion). Technometrics 26 305-330. Haff, L. R. (1986). On linear log-odds and estimation of discriminant coefficients. Commun. Statist.—Theor. Meth. 15 2131-2144. Hall, D. J. and Khanna, D. (1977). The ISODATA method of computation for relative perception of similarities and differences in complex and real data. In Statistical Methods for Digital Computers (Vol. 3). (K Enslein, A. Ralston, and H. W. Wilf, eds.) New York: John Wiley. Hand, D. J. (1981). Discrimination and Classification. Wiley, New York. Hartigan, J. A. (1967). Representation of similarity matrices by trees. J. Amer. Statist. Assoc. 62 1140-1158. Hartigan, J. A. (1975). Clustering Algorithms. Wiley, New York. Hartigan, J. A. (1977). Distribution problems in clustering. In Classification and Clustering (J. Van Ryzin, ed.) 45-71. Academic Press, New York. Hartigan, J. A. (1978). Asymptotic distributions for clustering criteria. Ann. Statist. 6 117-131. Hartigan, J. A. (1981). Consistency of single linkage for high density clusters. J. Amer. Statist Assoc. 76388-394. Hartigan, J. A. and Hartigan, P. M. (1985). The dip test of multimodality. Ann. of Statist. 1370-84. Hermans, J., Habbema, J., and Schaefer, R. (1982). The ALLOC8O package for discriminant analysis, Stat. Software Newsletter, 8 15-20. Hodson, F. R., Sneath, P. H. A. and Doran, J. E. (1966). Some experiments in the numerical analysis of archaeological data. Biometrika 53311-324. Hosmer, D. W. (1973). A comparison of iterative maximum likelihood estimates of the parameters of a mixture of two normal distributions under three different types of sample. Biometrics 29761-770. Huber, P. J. (1985). Projection pursuit (with discussion). Ann. Statist. 6701-726. International Mathematical and Statistical Library (1977). Reference manual library 1, ed. 6. Vol. 1. Houston. James, W. and Stein, C. (1961). Estimation with quadratic loss. Proc. Fourth Berkeley Symp. Math. Statist. Prob. 1 311-319. Jambu, M. and Lebeaux, M. O. (1983). Cluster Analysis and Data Analysis. North-Holland Publishing Company, Amsterdam. Jardine, C. J., Jardine, N. and Sibson, R. (1967). The structure and construction of taxonomic hierarchies. Math. Biosci. 1 173-179. Jennrich, R. I. (1962). Linear Discrimination in the Case of Unequal Covariance Matrices. Unpublished manuscript. Jennrich, R. and Moore, R. H. (1975). Maximum likelihood estimation by means of nonlinear least squares. Proceedings of the Statistical Computing Section, American Statistical Association, 57-65. Johnson, S. C. (1967). Hierarchical clustering schemes. Psychometrika 32241-254. Kettenring, J. R., Rogers, W. H., Smith, M. E., and Warner, J. L. (1976). Cluster analysis applied to the validation of course objectives. J. Educ. Statist. 1 39-57. Kleiner, B. and Hartigan, J. A. (1981). Representing points in many dimensions by trees and castles (with discussion). J Amer. Statist. Assoc. 76260-276. Lachenbruch P. A. (1975) Discriminant Analysis. Hafner Press, New York. Lachenbruch, P. A. (1982). Robustness of discriminant flirictions. SUGI-SAS Group Proceedings 7626-632. Landwehr J. M., Pregibon, D., and Shoemaker, K C. (1984). Graphical methods for assessing logistic regression models (with discussion). J Amer. Statist. Assoc. 7961-83. Lennington, R. K. and Rossbach, M. E. (1978). CLASSY: An adaptive maximum likelihood clustering algorithm. Paper presented at 1978 meeting of the Classification Society. Levisohn, J. R. and Funk, S. G. (1974). CLUSTER: A hierarchical clustering program for large data sets (n>100). Research Memo #40, Thurstone Psychometric Laboratory, University of North Carolina. Ling, R. F. (1973). A probability theory of cluster analysis. J. Amer. Statist. Assoc. 68159-169. Macqueen, J. (1967). Some methods for classification and analysis of multivariate observations. Proc. Fifth Berkeley Symp. Math. Statist. Prob. 1281-297. Marks, S. and Dunn, 0. J. (1974). Discriminant functions when covariance matrices are unequal. J. Amer. Statist. Assoc. 69 555-559. Mccullagh, P. and Nelder, J. A. (1983). Generalized Linear Models. Chapman and Hall, London. Mckay, R. J. (1978). A graphical aid to selection of variables in two-group discriminant analysis. Appl. Statist. 27259-263. Mckay, R. J. and Campbell, N. A. (1982a). Variable selection techniques in discriminant analysis. 1. Description. Br. J. Math. Stat. Psychol. 351-29. Mckay, R. J. and Campbell, N. A. (1982b). Variable selection techniques in discriminant analysis. II. Allocation. Br. J. Math. Stat. Psychol. 353041. Michener, C. D. and Sokal R. R. (1957). A quantitative approach to a problem in classification. Evolution ii 130-162. Mojena, R. (1977). Hierarchical grouping methods and stopping rules—An evaluation. Computer Journal 20359-363. Mojena, R. and Wishart, D. (1980). Stopping rules for Ward's clustering method. Proceedings of COMPSTAT. Physica Verlag 426-432. Morgan, J. N. and Sonquist, J. A. (1963). Problems in the analysis of survey data, and a proposal. J. Amer. Statist. Assoc. 58415-435. Nelder, J. A. and Wedderburn, R. W. M. (1972). Generalized linear models. J Roy. Statist. Soc. A 135 370-384. Morgan, J. N. and Messenger, R. C. (1973). THMD: a sequential search program for the analysis of nominal scale dependent variables. Institute for Social Research, U of Michigan, Ann Arbor. Olshen, R. A., Gilpin, E., Henning, H. Lewinter, M., Collins, D., and Ross., J., Jr. (1985). Twelve month prognosis following myocardial infarction: classification trees, logistic regression, and stepwise linear discrimination. Proceedings of the Berkeley Conference in Honor of Jerzy Neyman and Jack Kiefer. (L. LeCam and R. Olshen, eds.) 1 245-267. Wadsworth Advanced Books and Software, Monterey, Calif. and the Institute of Mathematical Statistics, Hayward, Calif. Pollard, D. (1982). A central limit theorem for k-means clustering. Ann. Prob. 10919-926. Pregibon, D. (1981). Logistic regression diagnostics. Ann. Statist. 9 705-724. Rabiner, L. R., Levinson, S. E., Rosenberg, A. E. and Wilpon, J. G. (1979). Speaker independent recognition of isolated words using clustering techniques. IEEE Trans. Accoust. Speech Signal Process. 27336-349. Rao, C. R. (1948). The utilization of multiple measurements in problems of biological classification. J. Roy. Statist. Soc. Ser. B 10159-203. Rao, C. R. (1952). Advanced Statistical Methods in Biometric Research. Wiley, New York. Rao, C. R. (1960). Multivariate analysis: an indispensable statistical aid in applied research. Sankhya 22317-338. Rao, C. R. (1962). Use of discriminant and allied functions in multivariate analysis. Sankhya A24 149-154. Rao, C. R. (1965). Linear Statistical Inference and Its Applications. Wiley, New York. Riffenburgh, R. H. and Clunies-Ross, C. W. (1960). Linear discriminant analysis. Pacific Science 14 251-256. Rohlf, F. J. (1977). Computational efficacy of agglomerative clustering algorithms. Technical Report RC-6831. IBM Watson Research Center Rohlf, F. J. (1982). Single-link clustering algorithms. In Handbook of Statistics: Vol. 2, (P. R. Krishnaiah and L. N. Kanal, eds.) 267-284. North-Holland Publishing Company, Amsterdam. Rotman, S. R., Fisher, A. D., and Staelin, D. H. (1981). Analysis of multiple-angle microwave observations of snow and ice using cluster analysis techniques. J. Glaciology 27 89-97. Ryan, T., Joiner, B., and Ryan, B. (1982). Minitab Reference Manual. Duxbury Press, Boston. SAS Institute, Inc. (1985). SAS User's Guide: Statistics, Version S Edition. Sas Institute, Inc., Cary, N.C. Seber, G. A. F. (1984). Multivariate Observations. Wiley, New York. Shepard, R. N. and Arabie, P. (1979). Additive clustering: representation of similarities as combinations of discrete overlapping properties. Psychological Review 8687-123. Shibata, R. (1981). An optimal selection of regression variables. Biometrika 6845-54. Sibson, R. (1973). SLINK: An optimally efficient algorithm for single-link cluster methods. Computer Journal 1630-34. Siegel, J. H., Goldwyn, R. M., and Friedman, H. P. (1971). Pattern and process in the evolution of human septic shock. Surgery 70232-245. Silverman, B. W. (1986). Density Estimation for Statistics and Data Analysis. Chapman and Hall, London. Smythe, R. T. and Wierman, J. C. (1978). First passage percolation on the square lattice. Lecture Notes in Mathematics 671. Springer-Verlag, Berlin. Sneath, P. H. A. and Sokal, R. R. (1973). Numerical Taxonomy. Freeman, San Francisco. Sokal, R. R. (1974). Classification: purposes, principles, progress, prospects. Science 185 1115-1123. SPSS, INC. (1986). SPSSX (a computer program). McGraw-Hill, New York. Stein, C. (1956). Inadmissibility of the usual estimator for the mean of a multivariate normal distribution. Third Berkeley Symp. Math. Statist. Prob. 1 197-206. Stone, C. J. (1977). Consistent nonparametric regression (with discussion). Ann. Statist. 5595-645. Stone, M. (1977). Cross-validation: a review. Math. Operationforsch. Statist. Ser. Statist. 9 127-139. Tarter, M. and Kronmal, R. (1970). On multivariate density estimates based on orthogonal expansions. Ann. Math. Statist. 4 718-722. Toussaint, G. T. (1974). Bibliography on estimation of misclassification. IEEE Transactions on Information Theory IT-20 472A79. Thuett, J., Cornfield, J. and Kannel, W. (1967). A multivariate analysis of the risk of coronary heart disease in Framingham. J of Chronic Diseases 20511-524. Thyon, R. C. (1939). Cluster Analysis. edwards Brothers, Ann Arbor, Mich. Vapnik, V. N. and Chervonenkis, A. YA. (1971). On the uniform convergence of relative frequencies of events to their probabilities. Theor. Prob. Appl. 16264-280. Vapnik, V. N. and Chervonenkis, A. YA. (1974). Theory of Pattern Recognition (in Russian). Nauka, Moscow. VELDMAN, D. J. (1967). FORTRAN Programming for the Behavioral Sciences. Holt, Rinehart and Winston, N.Y. Vrijenhoek, R. C., Douglas, M. E., and Meffe, G. K-(1985). Conservation genetics of endangered fish populations in Arizona. Science 229 100-402. Wald, A. (1944). On a statistical problem arising in the classification of an individual into one of two groups. Ann. Math. Statist. 15145-162. Walker, S. B. and Duncan, D. B. (1967). Estimation of the probability of an event as a function of several independent variables. Biometrika 54 167-179. Wishart, D. (1969). Mode Analysis: A generalization of nearest neighbor which reduces chaining effects in Numerical Taxonomy, (A. J. Cole, ed.), Academic Press, London. Wolfe, J. H. (1970). Pattern clustering by multivariate mixture analysis. Multivariate Behavioral Research S 329-350. Wolfe, J. H. (1971). A Monte-Carlo study of the sampling distribution of the likelihood ratio for mixtures of multinormal distributions. Research Memorandum 72-2, Naval Personnel and Research Training Laboratory, San Diego. H Sundaram, Y R Lin . . . —Signal Processing . . . , 2012-ieeexplore.ieee.org; Understanding Community Dynamics in Online Social Networks: A multidisciplinary R Xu, J Xu . . . —2012-ieeexplore.ieee.org; A Comparison Study of Validity Indices on Swarm-Intelligence-Based Clustering C Tu, S Jiao . . . —2012-Taylor & Francis; Comparison of clustering algorithms on generalized propensity score in observational studies: a simulation study Y Li . . . —Physics Procedia, 2012-Elsevier; A Clustering Method Based on K-Means Algorithm C C Chang . . . —Pattern Recognition, 2012-Elsevier; Semi-supervised clustering with discriminative random fields B Wang . . . —Procedia Engineering, 2012-Elsevier; Deceptive Financial Reporting Detection: A Hierarchical Clustering Approach Based on Linguistic Features Z Volkovich, D Toledano-Kitai . . . —Journal of Global . . . , 2012-Springer; Self-learning K-means clustering: a global optimization approach S Gulten . . . —2012-papers.ssrn.com; Two-Stage Portfolio Optimization with Higher-Order Conditional Measures of Risk P Sharma, S Salapaka . . . —Automatic Control, IEEE . . . , 2012-ieeexplore.ieee.org; Entropy-based framework for dynamic coverage and clustering problems X LOU, J L I . . . —Journal of Computational Information Systems, 2012-jofcis.com; Improved Fuzzy C-means Clustering Algorithm Based on Cluster Density Z Volkovich, G W Weber, R Avros . . . —International Journal of . . . , 2012-Inderscience; On an adjacency cluster merit approach C Beck, S Salapaka, P Sharma . . . —Distributed Decision Making and . . . , 2012-Springer; Dynamic Coverage and Clustering: A Maximum Entropy Approach K Lee . . . —Software Engineering Research, Management and . . . , 2012-Springer; A Market-Driven Product Line Scoping M Vlachos . . . —Information Visualization, 2012-ivi.sagepub.com; Recommendation and visualization of similar movies using minimum spanning dendrograms D C Guimaraes Pedronette . . . —Information Sciences, 2012-Elsevier; Exploiting pairwise recommendation and clustering strategies for image re-ranking J Wang, S Wu . . . —International journal of computational . . . , 2012-dro.deakin.edu.au; Clustering with instance and attribute level side information C Schifanella, M L Sapino . . . —Journal of Intelligent Information . . . , 2012-Springer; On context-aware co-clustering with metadata support S Y Bhat . . . —Proceedings of the 2nd International Conference . . . , 2012-dl.acm.org; A density-based approach for mining overlapping communities from social network interactions B N Devi, Y R Devi, B P Rani . . . —Procedia Engineering, 2012-Elsevier; Design and Implementation of Web Usage Mining Intelligent System in the Field of e-commerce G Navarro-Arribas . . . —Information Fusion, 2012-Elsevier; Information fusion in data privacy: A survey AB Dragut-Methodology and Computing in Applied Probability, 2012-Springer; Stock Data Clustering and Multiscale Trend Detection H Cheng, Y Zhou, X Huang . . . —Data Mining and Knowledge . . . , 2012-Springer; Clustering large attributed information networks: an efficient incremental computing approach K Treerattanapitak . . . —Journal of Computer Science and . . . , 2012-Springer; Exponential Fuzzy C-Means for Collaborative Filtering Y H Chen-Journal of Computational Biology, 2012-online.liebertpub.com; The k Partition-Distance Problem R Loohach . . . —mairec.org; An Insight Overview Of Issues And Challenges Associated With Clustering Algorithms, A Gulhane, P L Paikrao . . . —International Journal of Soft Computing-ijsce.org; A Review of Image Data Clustering Techniques B Auffarth-csc.kth.se; A Genetic Algorithm for Clustering with Biased Mutation Operator A Jayasimhan . . . —research.ijais.org; Anomaly Detection using a Clustering Technique T S Madhulatha-Arxiv preprint arXiv:1205.1117, 2012-arxiv.org; An Overview on Clustering Methods D Boley . . . —matrix-users.cs.cfac.uk; A General Unsupervised Clustering Tool for Unstructured Data B. Santhosh Kumar, V. Vijayaganth, Data Clustering Using K-Means Algorithm For High Dimensional Data, International Journal of Advanced Research In Technology (ijart.org); 2(1)22-32, February 2012 G Peters . . . —Wiley Interdisciplinary Reviews: Data Mining and . . . —Wiley Online Library; Dynamic clustering with soft computing B H Babu, N S Chandra . . . —interscience.in; Clustering Algorithms For High Dimensional Data—A Survey Of Issues And Existing Approaches B A Tidke, R G Mehta . . . —ijesat.com; A Novel Approach For High Dimensional Data Clustering T Naresh, G R Naidu . . . —ijera.com; Learning Subject Areas by Using Unsupervised Observation of Most Informative Terms in Text Databases J F Ehmke-Integration of Information and Optimization Models for . . . , 2012-Springer; Knowledge Discovery and Data Mining V Ilango, R Subramanian . . . —European . . . , 2012-europeanjournalofscientificresearch; A Five Step Procedure for Outlier Analysis in Data Mining Z Wang, X Sun . . . —red.pe.org.pl; Efficient Kernel Discriminative Geometry Preserving Projection for Document Classification S A Rios, R A Silva . . . — . . . of the 4th International Workshop on . . . , 2012-dl.acm.org; A dissimilarity measure for automate moderation in online social networks A Roshchina, J Cardiff . . . —lrec-conf.org; Evaluating the Similarity Estimator Component of the TWIN Personality-based Recommender System P Richhariya . . . —International Journal of Computer . . . , 2012-research.ijcaonline.org; A Survey on Financial Fraud Detection Methodologies R Salman-2012-digarchive.library.vcu.edu; Contributions To K-Means Clustering And Regression Via Classification Algorithms F Stahl . . . —Wiley Interdisciplinary Reviews: Data . . . , 2012-Wiley Online Library; An overview of the use of neural networks for data mining tasks T Schluter . . . —Proceedings of the 27th Annual ACM . . . , 2012-dl.acm.org; Hidden markov model-based time series prediction using motifs for detecting inter-time-serial correlations G Tilak, T Szell, R Chicheportiche . . . —Arxiv preprint arXiv: . . . , 2012-arxiv.org; Study of statistical correlations in intraday and daily financial return time series R Ghaemi, M N Sulaiman, H Ibrahim . . . —Memetic Computing, 2012-Springer; A novel fuzzy C-means algorithm to generate diverse and desirable cluster solutions used by genetic-based clustering ensemble algorithms P Zuccolotto-AStA Advances in Statistical Analysis, 2012-Springer; Principal component analysis with interval imputed missing values S Martinez, A Valls . . . —Knowledge-Based Systems, 2012-Elsevier; Semantically-grounded construction of centroids for datasets with textual attributes C N Vasconcelos, V Jardim, A Sa . . . —iris.sel.eesc.usp.br; Photo Tagging by Collection-Aware People Recognition R Cai, L Zhang . . . —US Patent 2012/0125178 (2012); Scalable Music Recommendation By Search K C L Liu-cc.gatech.edu; Vista: Looking Into the Clusters in Very Large Multidimensional Datasets Y Bu, B Howe, M Balazinska . . . —The VLDB Journal—The . . . , 2012-dl.acm.org; The HaLoop approach to large-scale iterative data analysis U C A Sironi-unige.ch; Bond Trading, Market Anomalies And Neural Networks: An Analysis With Kohonen Nets M Kruli, T Skopal, J Loko . . . —Distributed and Parallel . . . , 2012-Springer; Combining CPU and GPU architectures for fast similarity search J Derrac, I Triguero, S Garcia . . . —IEEE transactions on . . . , 2012-ieeexplore.ieee.org; Integrating Instance Selection, Instance Weighting, and Feature Weighting for Nearest Neighbor Classifiers by Coevolutionary Algorithms. R Baraglia, P Dazzi, M Mordacchini . . . —Journal of Computer and . . . , 2012-Elsevier; A Peer-to-Peer recommender system for self-emerging user communities based on Gossip overlays J Gao, W Hu, Z Zhang . . . — . . . in Knowledge Discovery and Data Mining, 2012-Springer; Unsupervised Ensemble Learning for Mining Top-n Outliers H T Zheng . . . —Expert Systems with Applications, 2012-Elsevier; Towards Group Behavioral Reason Mining L F Robinson-cis.jhu.edu; Detecting Time-dependent Structure in Network Data via a new Class of Latent Process Models H S Le, Z Bar-Joseph, C Langmead, R Rosenfeld . . . —cs.cmu.edu; Probabilistic models for collecting, analyzing and modeling expression data D Yang-2012-wpi.edu; Mining and Managing Neighbor-Based Patterns in Data Streams C Fournier . . . —Arxiv preprint arXiv:1204.2847, 2012-arxiv.org; Segmentation similarity and agreement C H Wan, L H Lee, R Rajkumar . . . —Expert Systems with Applications, 2012-Elsevier; A hybrid text classification approach with low dependency on parameter by integrating K-nearest neighbor and support vector machine H C Wu, R W P Luk, K F Wong . . . —Information Processing & . . . , 2012-Elsevier; A split-list approach for relevance feedback in information retrieval V J Hodge, T Jackson . . . —www-users.cs.york.ac.uk; Intelligent Decision Support using Pattern Matching H Le Capitaine-Fuzzy Systems, IEEE Transactions on, 2012-ieeexplore.ieee.org; A relevance-based learning model of fuzzy similarity measures K Rybina-rn.inf.tu-dresden.de; Sentiment analysis of contexts around query terms in documents T F de Master-2012-ir.ii.uam.es; Novelty and Diversity Enhancement and Evaluation in Recommender Systems B Mianowska . . . —Multimedia Tools and Applications, 2012-Springer; Tuning user profiles based on analyzing dynamic preference in document retrieval systems M Drosou . . . —2012-cs.uoi.gr; Dynamic Diversification of Continuous Data G Ganu, Y Kakodkar . . . —Information Systems, 2012-Elsevier; Improving the quality of predictions using textual information in online user reviews E Carrizosa . . . —Computers & Operations Research, 2012-Elsevier; Supervised classification and mathematical optimization X Zhou-2012-gradworks.umi.com; Learning functions on unknown manifolds K Kitto . . . —per.marine.csiro.au; Attitudes, Ideologies And Self-Organisation: Information Load Minimisation In Multi-Agent Decision Making R Pivovarov . . . —Journal of Biomedical Informatics, 2012-Elsevier; A hybrid knowledge-based and data-driven approach to identifying semantically similar concepts K M Fouad, A R Khalifa, N M Nagdy . . . —2012-ijcsi.org; Web-based Semantic and Personalized Information Retrieval Semantic and Personalized Information Retrieval Semantic and Personalized Information . . . A P Streib-2012-aco.gatech.edu; Markov Chains At The Interface Of Combinatorics, Computing, And Statistical Physics I T Christou, G Gekas . . . —International Journal of Machine Learning and . . . —Springer; A classifier ensemble approach to the TV-viewer profile adaptation problem J Joenvaara, R Kosowski . . . —2012-papers.ssrn.com; Revisiting ‘Stylized Facts’ About Hedge Funds-Insights from a Novel Aggregation of the Main Hedge Fund Databases I Abraham, S Chechik, D Kempe . . . —Arxiv preprint arXiv: . . . , 2012-arxiv.org; Low-distortion Inference of Latent Similarities from a Multiplex Social Network E Lloret, A Balahur, J M Gomez, A Montoyo . . . —Journal of Intelligent . . . , 2012-Springer; Towards a unified framework for opinion retrieval, mining and summarization Y Su . . . —International Journal of Computer Vision, 2012-Springer; Improving Image Classification Using Semantic Attributes D Vandic, J W van Dam . . . —Decision Support Systems, 2012-Elsevier; Faceted product search powered by the Semantic Web A Watve-2012-cse.msu.edu; Data Transformation For Improved Query Performance EC Dragut, W Meng . . . —Synthesis Lectures on Data . . . , 2012-morganclaypool.com; Deep Web Query Interface Understanding and Integration M Keshavarzi, M A Dehghan . . . —Fuzzy Information and . . . , 2012-Springer; Applications of classification based on similarities and dissimilarities Y Zhang-2012-cs.cmu.edu; Learning with Limited Supervision by Input and Output Coding J Rousu-cs.helsinki.fi; Efficient Range Partitioning in Classification Learning M Berg-lib.tkk.fi; Human Abilities to Perceive, Understand, and Manage Multi-Dimensional Information with Visualizations E Vasileios . . . —2012-ics.forth.gr; A real-time semantics-aware activity recognition system L Boratto-2012-veprints.unica.it; Group recommendation with automatic detection and classification of groups A Van Giessen-2012-repository.tudelft.nl; Dimension Reduction Methods for Classification Gitanjali Swamy, R, Brayton, ISBN:0-591-32212-9, University of California, Berkeley, 1996 Incremental methods for formal verification and logic synthesis”. G. M. Swamy, S. Edwards, R. Brayton, In the Proceedings of the IEEE International Conference on VLSI Design, Hyderabad, January 1998. “Efficient Verification and Synthesis using Design Commonalities”. G. M. Swamy, P. McGeer, R. Brayton, In the Proceedings of the International Workshop on Logic Synthesis, Tahoe Calif., May 1993 “A Fully Implicit Quine-McClusky Procedure using BDDs”. Christophe Jouis; Ismail Biskri; Jean-Gabriel Ganascia; Magali Roux, “Next Generation Search Engines”, IGI GlobalPub, Mar. 31, 2012 (ISBN-10: 1-4666-0330-5).

### SUMMARY AND OBJECTS OF THE INVENTION

According to one embodiment of the technology, a plurality of computer-mediated digital communications produced by identified authors who are employees within a corporation is collected and parsed to index its similarity to a defined set of communications of the same or similar type in order to derive a set of scores for that employee based on the totality of indexed similarity between the defined communication set (example set) and the set of communications associated with each participating employee of the corporation.

The categories of information are processed with at least one analysis to quantify at least one index of similarity in each category. A first output communication is generated regarding the totality of similarity indices among a plurality of employee-specific computer-mediated communications and a defined set of example sets, describing the relative degree of performance competence indicated by the indexed similarity to the defined example set or sets. A second output communication is generated regarding the totality of similarity indices among a plurality of employee-specific computer-mediated communications and a defined set of example sets, describing the relative degree and type of behavioral risk.

The aforementioned output communications may also contain recommendations for independent, follow-up psychometric assessment of employees using proprietary item sets and scales to either confirm the types of indicated performance competence or to establish the level of measured risk propensity associated with the employee's responses to the assessment items. A combination of behavioral indices based on example set proximities and propensity indices based on related psychometric assessment drive recommendations of specific proactive and remedial actions to optimize the human capital value of persons and the corporations with which they are associated.

U.S. Pat. No. 8,775,162 thus utilizes a scheme to measure the quantity and emotional tone of communications. However, in addition to the number of communications, the current invention utilizes the length, frequency per time period and other characteristics of the communications. In addition to the percent of insertions which are positive, the current invention initially examines the percent which are positive or negative, or both. Instead of coding the percent positive by observation, the current invention automatically codes the content of the communications in a more complex fashion utilizing psychological content analysis categories such as negative and positive feelings, negative and positive evaluators and negatives. The user can then examine the actual content associated with this coding to determine the content associated with the emotional tone. In addition, the authors never applied their scheme to the computerized communications of individuals, changes in the emotional tone of these communications over time, support for managing these media- and computer-based relationships, monitoring and assessing potential risk from an individual's psychological state, or personnel selection processes.

A distinction contained herein from U.S. application 20150206103 from one embodiment of the technology lies in the focus of content analytics vs. process analytics. The present process, for example, analyzes the text strings of behavioral interview answers extracted from the audio files obtained from online video interviews, or the text files obtained directly via text boxes counted in a web page served by a browser resident in a smart phone, tablet, or personal computer for their similarity, using lexical semantic indexing, to index each new answer's similarity to example sets of previously collected and evaluated interview answers obtained from candidates applying to the same position title or a similar type of work.

The present invention is a method of and system for computerized content similarity analysis of computer stored communications authored by employees of a corporation with example sets of stored communications assembled to represent specific types of competent or counter-productive communications which result in data tables and maps that facilitate personal behavioral change coaching and corporate personnel decision making based on an objective analysis of mathematical properties of the example set communications compared to those same properties computed for each instance of an employee digital communication. As a result, corrective action to an individual's projected course of behavior can be recommended to lessen or eliminate risky behavior to enhance the relationship and safety and the operation of an organization to which the author is affiliated, or to provide the author with suggestions on how to better leverage behavioral competency evidenced in the communications instances found to closely resemble meritorious example sets.

A plurality of computer or media generated communications produced by an author affiliated as an employee to a specific organization is collected, representing an approximate totality of that employee's digital communication record within a specified targeted timeframe. The collected communications are analyzed to quantify the similarity between each communication and previously collected and selected examples of similar structural types of communications that exemplify either top, typical, or terrible levels of competence of a specific defined type or trivial, typical, or terrible levels of malfeasance of a specific, defined, type. An output communication is generated that tables the means and standard deviations of the employees' similarity indices, analyzed by example set over the totality of that employee's collected communications. An output communication is generated that further averages these statistics for functional, geographical, business unit or other segmentation of the totality of employees analyzed for a specific corporation or collection of corporations within a given industrial or market sector, at the discretion of the user.

The output communication may be programmed to be varied in nature to address diverse applications of the invention. The programming of the content of the output communication and the actions that should be taken permits users of the invention to customize the criteria for screening computer-mediated communications to detect those computer-mediated communications which the user deems important enough to provide a responsive action and further the nature of the action to be taken, such as modifying communication with the author of the analyzed communication, issuing a written warning, or invoking psychological counseling, so as to minimize or eliminate disruptive or dangerous situations. For example, in the case of an example set that contains negatively phrased and/or insulting communications, the output communication may be a warning that the analyzed communication contains high levels of negativity and/or disparaging content which could damage a potential relationship and the employer's consumer or employment brand. The programmed criteria for generating the warning or other feedback are selected by the user. For example, the warning may be generated only if the indices of example set similarity to a specific type of malfeasant behavior for a specific employee fall within identified overall ranges, or if a significant change over time between an average, mean or other calculation or otherwise quantification of previous computer-mediated communications received or prepared by the author and a more recent computer mediated communication is detected. Alternatively, career celebration and acceleration recommendations may be generated for the employee whose similarity indices fall in specific zones to specific example sets that target strategically important instances of competent contribution to achieving corporate objectives.

Users of the present technology will have options, including monitoring designated categories of individuals, communications, and employees, monitoring employees at risk or under suspension, employees who demonstrate exceptional growth and competence, and general monitoring.

For example, within organizations, sensitive positions of trust exist where the employee has the capacity to significantly damage the organization. For example, system administrators running a bank's on-line customer service operations or other information technology have the capacity to substantially damage the bank at will. Therefore, it is desirable that administrators having responsibility for critical business infrastructure be subject to higher levels of monitoring and real time monitoring of possible malfeasant actions, as captured by the employee's internal and external communications. Alternatively, roles that deliver exceptional and pivotal levels of positive impact on the corporation's financial success also exist, imbuing short cycle feedback on the presence of forms of extreme competence, and changes in competence patterns, with exceptional value to corporate executives.

Employees at risk or under suspension may include individuals on probation due to psychological or behavioral difficulties that do not yet merit removal from the workplace or individuals who are returning from leave or rehabilitation after removal due to these difficulties. This type of employee may include individuals under investigation for a violation. Employees in pivotal contribution roles may include individuals who have been rapidly advanced into positions of greater authority or financial impact or managers who oversee increasingly large portions of a corporation's revenue or risk.

A self-monitoring embodiment uses the psychological profiling algorithms discussed above and below to produce graphics or tabular ratings of the content of a computer mediated communication, scoring for similarity to example sets selected and approved by SMEs (Subject Matter Experts) and executives as critical to achieving the corporation's strategic objectives or as containing significant risk of loss, whether that be loss of existing revenue, opportunity cost, or outlay costs associated with damage to property, equipment or brand loyalty.

The output communication may indicate that the author or his or her communication should be studied. One or more analyses may be used to process the categories of information, with the analyses including at least one psychological profiling algorithm which provides an indication of a psychological state, attitude or characteristics of the author, at least one key word algorithm which processes any phrases and/or threatening acts to further identify a psychological state of the author and how the author may react to the identified psychological state, attitude or characteristic, and at least one communication characteristic algorithm which analyzes characteristics of the at least one computer mediated or media generated communication to identify a psychological state, attitude or characteristic and/or at least one possible action of the author.

The collection of computer mediated or media generated communications may be email, chat from a chat room, website information collected from a website, documents authored by the employee, or transcribed media coverage. The author may be affiliated with an organization and the output communication may pertain to a course of action to be taken by the organization which collected the at least one computer mediated communication authored or received by the author.

The technology provides, according to one aspect, a system and method which receives plurality of computer-mediated digital communications, produced by identified authors who are employees within a corporation or associated with an entity, collected and parsed to index their similarity to a defined set of communications of the same or similar type in order to derive a set of scores for that employee based on the totality of indexed similarity between the defined communication set (example set) and the set of communications associated with each participating employee of the corporation. The categories of information are processed with at least one analysis to quantify at least one index of similarity in each category. A first output communication is generated regarding the totality of similarity indices among a plurality of employee-specific computer-mediated communications and a defined set of example sets, describing the relative degree of performance competence indicated by the indexed similarity to the defined example set or sets. A second output communication is generated regarding the totality of similarity indices among a plurality of employee-specific computer-mediated communications and a defined set of example sets, describing the relative degree and type of behavioral risk. The aforementioned output communications also contain recommendations for independent, follow-up psychometric assessment of employees using proprietary item sets and scales to either confirm the types of indicated performance competence or to establish the level of measured risk propensity associated with the employee's responses to the assessment items. A combination of behavioral indices based on example set proximities and propensity indices based on related psychometric assessment drive recommendations of specific proactive and remedial actions to optimize the human capital value of persons and the corporations with which they are associated.

The present technology shares similar input and purposes outlined in U.S. Pat. No. 8,775,162, but extends the technology in important ways.

First, it applies completely different computer algorithms to index the similarity between each person's communication instances to the plurality of communications contained in each of one or more pre-existing example sets, resulting in each person's communication receiving a score indexing it's similarity to the plurality of communications in each of the example set types. Previous approaches, culminating in U.S. Pat. No. 8,775,162, generated output communications based on identifying characteristics of the content of a communication against an identified model of effective vs. disruptive behavior. The present technology does not rely on a specific content theory, but instead focuses the indexing algorithm on the mathematical representations of example sets.

Second, the personal index of behavioral risk or competence consists of an aggregation of the risk or competence scores attached to each of the example sets for each of the employees of the corporation associated with the communication authors.

Third, instead of scoring communications against a single theoretical model of desirable and undesirable communications, the scoring in this invention is driven by the mathematical characteristics of the words contained in multiple example sets of a plurality of existing documents that have been evaluated to have specific, targeted qualities.

A computer system in accordance with the present invention may be implemented in one or more processors to detect, monitor and warn of the occurrence of psychological states, such as at risk psychological states, in computer-mediated communications of authors who transmit or receive computer-mediated communications, such as, but not limited to, email, chat, website content, etc. Computer-mediated communications have been recognized in the literature as having characteristics that are different from those of other forms of communication such as speech or publications. This is applicable to a wide range of applications involving group associations, such as companies, for whom an author of computer-mediated communications works or provides services. The at least one processor is typically located on the site of the organization with whom the author, who transmits or receives the computer-mediated communications, is affiliated, but the invention is not limited thereto. The at least one processor may be a server, personal computer or otherwise. The at least one processor further may be a stand-alone system or part of any existing system of a company which already monitors electronic mail and/or other computer-mediated communications. By combining the present invention with an existing system that monitors computer-mediated communications, parts of the existing system, such as a part which generates output communications and reports, may perform multiple tasks, which lessens the cost when compared to a stand-alone system.

A source of computer-mediated communications, which may be from any connection to the internet or diverse types of communication networks, or otherwise, is a source of or destination of electronic mail, chat, web content, etc., that is analyzed by the present invention. The invention applies the same analysis to computer-mediated communications which are transmitted or which are received by the author in association with the author's organization.

Methods and systems for the electronic, objective coaching of behavioral answers and scoring of the text extracted from answers to a plurality of job-related behavioral interview questions collected from a plurality of persons are described. In one embodiment, behavioral answer text is extracted from an audio file obtained when interviewees verbally answer questions into an internet-connected microphone such that the audio file is stored and subjected to voice-to-text software that delivers the collection of words in a text string. In a second embodiment, interviewees type answers into a web page text box, guided by answer-specific probes and coaching statements. However collected, the collected text strings are scored by a natural language analytics engine that deploys latent semantic indexing to evaluate the similarity between the text collected from a new target answer, and question-specific example sets of previously collected answers identified by Job Experts as associated with superlative, typical, and ineffective performance on the performance construct targeted by the example set. This scoring method extends the prior art as documented in previous patent applications cited below in material and important ways that the published interviewing literature suggests will boost predictive accuracy of the interviewee performance score beyond what is possible from quantitatively scoring interview answers focusing on the physical metrics of the answer.

According to the present technology, the example sets for a specific question may consist of previously collected text strings extracted from answers to the same behavioral question prompt given to the candidate whose answer is being evaluated. The previously collected answers were evaluated by job experts (direct supervisors and/or hiring managers) as describing superlative performance (defined as among the top 15% of all answers), typical performance (defined as among the middle 30% of all answers) or poor performance (defined as being in the bottom 15% of all answers). Example sets may contain from 20 to 100 answers of each type. The lexical semantic indexing SAAS solution (such as CAAT, available from ContentAnalysis.com) delivers an index score from 1 to 10, where 1 signifies the lowest predicted future job performance on the performance construct addressed by the question, and a score of 10 signifying the highest level of future job performance.

A weighted composite of the candidate's example set scores on all of the questions associated with the job title or class forms the candidate's overall behavioral interview score. This score is combined in a linear weighted composite with other information collected prior to or following the online interview to create the candidate's predicted overall future performance score.

It is therefore an object to provide a method of behavior assessment, comprising: acquiring a video stream of an interviewee responding to a set of interview prompts; analyzing at least a semantic content of interviewee's response; statistically processing, with at least one automated processor, the interviewee's response according to a correspondence of the interviewee's response to a set of classified exemplar responses collected from prior interviewees, and a context, to evaluate the interviewee with respect to the performance construct or constructs underlying the question that stimulated the response; and generating at least one output selectively dependent on the classification of the interviewee.

It is also an object to provide a method for of assessment of an human, comprising acquiring human communications comprising at least one of a video stream of an interviewee responding to a set of interview prompts and a corpus of documents authored or edited by the human; determining at least a semantic content of the human communications; statistically processing, with at least one automated processor, the semantic content of the human communications, to determine a correspondence of the analyzed human communications to a set of classified human communications comprising at least one of exemplar responses collected from prior interviewees' respective responses to corresponding respective interview prompts in a context, and classified corpuses of documents authored or edited by humans, to evaluate the human; and generating at least one output selectively dependent on the statistical processing.

The statistical processing may comprise clustering.

The interviewee's response may comprise at least semantic content, visual cues, and timing of response, further comprising clustering comprises multimodal clustering.

The context may comprise an employment opportunity.

The context may comprise a potential coworker, to predict performance of the interviewee working with the potential coworker.

A transcript of the interviewee's response may be evaluated according to latent semantic indexing.

The method may further comprise: storing a plurality of interviewee's responses; receiving an input from a potential employer of a defined context; and producing at least one of a ranked list of interviewees and a subset of identifications of the interviewees that meet threshold criteria.

The method may further comprise outputting at least one hyperlink responsive to a respective interviewee's response.

The acquiring may comprise automatically prompting an interviewee to generate the interviewee's responses, substantially without real-time involvement of an interviewer.

The method may further comprise producing a score of text analytics of a transcript of the interviewee's responses.

The method may further comprise receiving a human user classification of at least one exemplar response to generate a respective classified exemplar response.

The method may further comprise presenting the human user with a competency definition and a reference response, and the classification of the exemplar response may comprise at least two non-binary ratings of independent characteristics.

A plurality of human users may each classify the same exemplar response, further comprising determining an inter-user agreement rating for the classification. A plurality of human users may each classify the same exemplar response, the method further comprising determining a discrimination factor for the classification with respect to at least one of the at least two non-binary ratings of independent characteristics.

The method may further comprise determining an accuracy of the evaluation of the interviewee with respect to the performance construct or constructs underlying the prompt that stimulated the response.

The method may further comprise receiving feedback information reflecting a performance of the interviewee after the evaluation of the interviewee, and updating a statistical model for the statistical processing based on at least the feedback.

The analyzing step for analyzing at least the semantic content of interviewee's response may comprise processing the interviewee's response with a natural language speech analyzer, further comprising receiving feedback information reflecting a performance of the interviewee after the evaluation of the interviewee, and updating the natural language speech analyzer based on at least the feedback.

The method may further comprise modifying a set of interview prompts for subsequent interviewees based on at least a performance of at least one interviewee after the evaluation.

The method may further comprise modifying a weighting of interviewee responses to the set of interview prompts in the statistical processing, for subsequent interviewees based on at least a performance of at least one interviewee after the evaluation.

The method may further comprise modifying a weighting of interviewee responses to the set of interview prompts in the statistical processing, for subsequent interviewees based on at least a performance of at least one interviewee after the evaluation.

The method may further comprise determining which interview prompts from a database of interview prompts comprise the set of interview prompts, selectively based on prior interviewee responses and prior interviewee performance after a respective evaluation of the respective prior interviewee, predicted in increase an accuracy of the evaluation of the interviewee.

It is also an object to provide a knowledge-based system, adaptive to historical experience, configured to select, for a respective interviewee and interview context, at least one of: a most apposite set of interview prompts; an optimal weightings of a set of interview prompts; and an optimized example set for scoring of interview prompts, given a selected set of restrictive parameters selected from one or more of the group consisting of an industry, a job role, a speed of performance, and a quality standard.

It is a further object to provide non-transitory computer readable media storing instructions for controlling an automated processor for implementing any of the methods disclosed herein, individually, in various combinations, subcombinations or permutations.

It is also an object to provide an apparatus configured to perform any of the methods disclosed herein, individually, in various combinations, subcombinations or permutations.

It is a further object to provide a method of behavior assessment, comprising: acquiring a document authored or edited by a subject; adding the acquired document to a corpus of documents of the subject; analyzing at least the semantic content of the corpus of documents; statistically processing, with at least one automated processor, the corpus of documents according to a correspondence of the subject's corpus of documents to a plurality of classified corpuses of documents from other humans, and a context, to classify the subject with respect to the context; and generating at least one output selectively dependent on the classification of the subject.

The statistical processing may comprise clustering or semantic clustering.

The corpus of documents comprise email.

The context may comprise an employment opportunity, thereby to predict the performance of the subject with respect to the employment opportunity.

The context may comprise a potential coworker, thereby to predict the performance of the subject with respect to the potential coworker.

The method may further comprise: storing a plurality of subject corpuses of documents; receiving an input from a potential employer of a defined context; and producing at least one of a ranked list of subjects and a subset of identifications of the subjects that meet threshold criteria.

The method may according to claim 23, further comprising outputting at least one hyperlink to a respective subject's corpus of documents.

The method may further comprise producing a score for the subject's corpus of documents.

The method may further comprise receiving a human user classification of at least one corpus of documents to generate a respective classified corpus of documents.

The method may further comprise presenting the human user with a competency definition and an unclassified corpus of documents, and the classification of the unclassified corpus of documents may comprise at least two non-binary ratings of independent characteristics.

A plurality of human users may each classify the same unclassified corpus of documents, further comprising determining an inter-user agreement rating for the classification.

A plurality of human users may each classify the same unclassified corpus of documents, further comprising determining a discrimination factor for the classification with respect to at least one of the at least two non-binary ratings of independent characteristics.

The method may further comprise producing a metric representing a distance between the subject's corpus of documents and an exemplar derived from the classified corpus of documents.

The classification of the subject may comprise a psychometric assessment of the subject. The acquiring of a document may comprise automatically analyzing documents in at least one of a document archive and an email server.

The method may further comprise generating a personnel recommendation selectively in dependence on the classification of the subject.

The classification of the subject may comprise a psychometric assessment of the subject, further comprising: maintaining a database of classifications of a plurality of subjects; receiving at least one of a target psychometric profile for an assignment and information defining a target psychometric profile for an assignment; automatically comparing the classifications of the plurality of subjects with the at least one of the target psychometric profile for the assignment and information defining the target psychometric profile for the assignment; and automatically generating at least one recommendation of a subject for the assignment.

The method may further comprise determining an accuracy of the classification of the subject with respect to the context.

The method may further comprise receiving feedback information reflecting a performance of the subject after the classification, and updating a statistical model for the statistical processing based on at least the feedback.

The analyzing at least the semantic content of the corpus of documents may comprise processing the corpus of documents with a natural language speech analyzer, further comprising receiving feedback information reflecting a performance of the subject after the classification, and updating the natural language speech analyzer based on at least the feedback.

It is another object to provide a method for the computerized analysis of a plurality of digital communications originated by a plurality of persons, comprising: receiving a compendium of documents; processing, with a computer, a content of each document of the compendium of documents according to a natural language computer algorithm based on at least latent semantic indexing, to score a similarity of each document of the compendium of documents against at least one previously classified sets of documents; and storing in a database the aggregate score for each respective person.

Each document may be evaluated on latent continua related to the document authors' performance as an employee of the corporation based on the semantic analysis of the document relative to the previously evaluated at least one previously classified sets of documents.

The natural language computer algorithm may compare each document against at least one previously classified sets of documents which has a similar document type and document structure.

Each document may have 30 or more words and may be less than three years old.

The compendium of documents may comprise records of a single entity.

The method may further comprise generating an output comprising a visual display of information that graphically represents values of the database.

The visual display may comprise a ranked representation of a combined score for a plurality of documents authored by a respective person.

The ranked representation may be provided in ascending order, and the plurality of documents authored by a respective person may comprise a predefined subset of the documents according to their respective scores.

The predefined subset may comprise the ten lowest scores, resulting in a risk map.

The method may further comprise generating a communication comprising a proposed action responsive to scores for at least a portion of the documents authored by a respective person.

The at least a portion may comprise a subset of the documents selected according to respective documents scores, and represents a risk to an entity association with the compendium of documents.

The communication may represent a risk warning regarding the respective person.

The method may further comprise performing a psychometric test on a respective person, and classifying documents authored by the respective person according to at least a result of the psychometric test.

The method may further comprise generating a task assignment recommendation based on the scores of documents authored by a respective person.

The method may further comprise determining an accuracy of the score of the similarity.

The method may further comprise adaptively updating the natural language computer algorithm dependent on the determined accuracy.

It is another object to provide a method comprising: receiving a plurality of example sets of answers to interview questions; characterizing the received a plurality of exemplar sets of responses answers to interview prompts by interview subject experts as being one of superlative, typical, and ineffective on a construct addressed in the prompt; receiving an interviewee respond to a performance-related behavioral prompt through an automated interviewee answer capture system; and scoring a received interviewee response comprising a text string via a software algorithm executing on a processing device, to statistically index a similarity of the received interviewee response to the characterized plurality of example sets corresponding to the performance-related behavioral prompt, to characterize the interviewee response on the construct addressed in the question.

The method may further comprise: receiving a plurality of interviewee responses to a plurality of performance-related behavioral prompts through the automated interviewee response capture system; and scoring a plurality of received interviewee responses, each comprising a text string via a software algorithm executing on a processing device, to index a similarity of each received interviewee response to the characterized plurality of example sets corresponding to the respective performance-related behavioral prompts, to characterize the interviewee with respect to the respective constructs addressed in the plurality of performance-related behavioral prompts as being one of superlative, typical, and ineffective, by integrating the scores for the respective performance-related behavioral prompts into a single aggregate score for the interviewee.

It is another object to provide a system for characterizing an interviewee, comprising: an input configured to receive an interviewee response to a performance-related behavioral prompt through an automated interviewee answer capture system; at least one automated processor configured to automatically score information corresponding to the received interviewee response, based on at least latent semantic indexing of a text string, to statistically index a similarity of the received interviewee response to characterizations of a plurality of example sets from other interviewees to the performance-related behavioral prompt; and at least one memory configured to store information characterizing the interviewee response with respect to the performance-related behavioral prompt based on the scoring.

The scoring may quantify a similarity of the text string to at least three example sets as a scalar parameter.

The interview subject experts may be job experts for a respective job having a job class associated with the performance-related behavioral prompts, and the scoring is predictive of future job success of the interviewee for that job class.

The text string may be obtained from the interviewee answer through speech-to-text software analysis.

The receiving step may comprise receiving at least audio information though a microphone over the Internet by an automated Internet server.

The performance-related behavioral prompt may be associated with at least one of a class of work and a specific position opening.

The method may further comprise providing automated feedback to the interviewee based on the scoring.

The method may further comprise accepting a second interviewee response to the performance-related behavioral prompt after the automated feedback is provided.

The scoring may comprise performing a latent semantic indexing algorithm.

A plurality of scores for each interviewee may be combined into a single prediction score for that respective interviewee using a set of linear combination weights derived from a professional judgement of the interview subject experts.

The method may further comprise determining an accuracy of the software algorithm with respect to a predicted performance of the interviewee.

The method may further comprise receiving feedback information reflecting a performance of the interviewee after said scoring, and updating the software algorithm based on at least the feedback.

The software algorithm may comprise a natural language speech analyzer, further comprising receiving feedback information reflecting a performance of the interviewee after said scoring, and updating the natural language speech analyzer based on at least the feedback.

The method may further comprise modifying the set of interview questions for subsequent interviewees based on at least a performance of at least one interviewee after the scoring.

The method may further comprise modifying a weighting of interviewee answers to the set of interview questions by the software algorithm, for subsequent interviewees, based on at least a performance of at least one interviewee after the scoring.

The method may further comprise modifying a weighting of interviewee answers to the set of interview questions by the software algorithm, for subsequent interviewees, based on at least a performance of at least one interviewee after the scoring.

The method may further comprise selecting, from a database of interview questions, the set of interview questions, based on prior interviewee answers and prior interviewee performance after a respective soring, predicted in increase an accuracy of the scoring of the interviewee.

It is a further object to provide a method for the computerized analysis of a plurality of free form text semantic documents originated by a person responding in writing to specific prompts, to form a compendium of documents, comprising: receiving the compendium of documents; processing, with a computer, a content of each document of the compendium of documents according to a natural language computer algorithm, based on at least latent semantic indexing, to score a similarity of each document of the compendium of documents against at least one previously classified sets of documents; storing in a database the aggregate score of the compendium of documents for the person, the database being configured to store at least the aggregate score for a plurality of persons; and at least one of: assessing the person's knowledge on a topic related to that person's future job performance; assessing a characteristic of an organization that employs the person responding; and assessing a characteristic of a business opportunity raised by the specific prompts.

Each document may be evaluated based on latent continua related to the person's level of content knowledge, based on the latent semantic indexing of the document relative to the previously classified sets of documents, according to a classification criteria comprising meritorious, neutral, and counter-productive.

Each document may be evaluated based on latent continua, based on the latent semantic indexing of the document relative to the previously classified sets of documents, according to a cumulative evaluation of organization characteristics over at least one of: a plurality of persons responding in writing to the specific prompts; a plurality of persons associated with the organization; a plurality of persons employed by the organization or an identifiable unit or location of the organization.

The organization may be a business organization.

Each document may be evaluated based on latent continua, based on the latent semantic indexing of the document relative to the previously classified sets of documents, according to a cumulative evaluation of organization characteristics over a cumulative evaluation of the strength of the business opportunity with respect to the responses of the person for consideration of the raised business opportunity.

The natural language computer algorithm compares each document against at least one previously classified sets of documents which has a similar document type and document structure.

### BRIEF DESCRIPTION OF THE DRAWINGS

These and other aspects and advantages of the present invention are more apparent from the following detailed description and claims, particularly when considered in conjunction with the accompanying drawings in which like parts bear like reference numerals. In the drawings:

FIG. 1 illustrates a block diagram of a first embodiment of the present invention.

FIG. 2 illustrates a continuation of FIG. 1.

FIG. 3 is a block diagram of an exemplary network architecture.

FIG. 4 is a block diagram of an answer evaluation phase of system operation.

FIG. 5 illustrates the example set configuration module of the system.

### DETAILED DESCRIPTION OF THE PREFERRED EMBODIMENTS

The invention will now be described with reference to the figures.

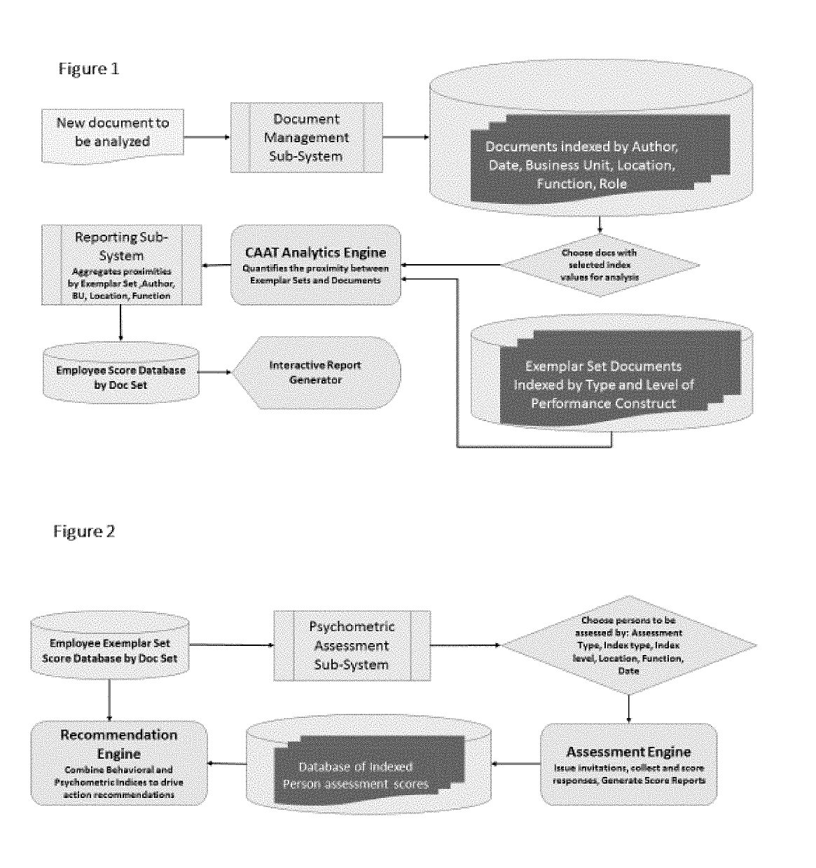

FIG. 1 illustrates a block diagram of a first embodiment of a computer system in accordance with the present invention utilized to analyze computer-mediated communications to produce output communications, such as:

(1) quantitative or graphical summaries of the level of behavioral competence or risk associated with a an indexed set of authors or an individual author of a set of digital communications stored within a corporate data trove, or

(2) recommended actions designed to contain or mitigate corporate risk associated with an indexed set of authors or an individual author for those example sets containing malfeasant instances, or

(3) recommended actions designed to leverage and promote positive corporate outcomes associated with an individual author for those example sets containing instances of specified types of competence.

FIG. 2 illustrates a continuation of the FIG. 1 block diagram, which includes a confirmation and extension of the conclusions that can be reached via the summary indices of behavioral competence or risk, vis-à-vis the example sets to a psychometric assessment of the same or similar constructs as were used to define the example sets. The psychometric assessments go to indexing the person's risk propensity (in the case of malfeasant behavior) or performance potential (in the case of competent behavior).

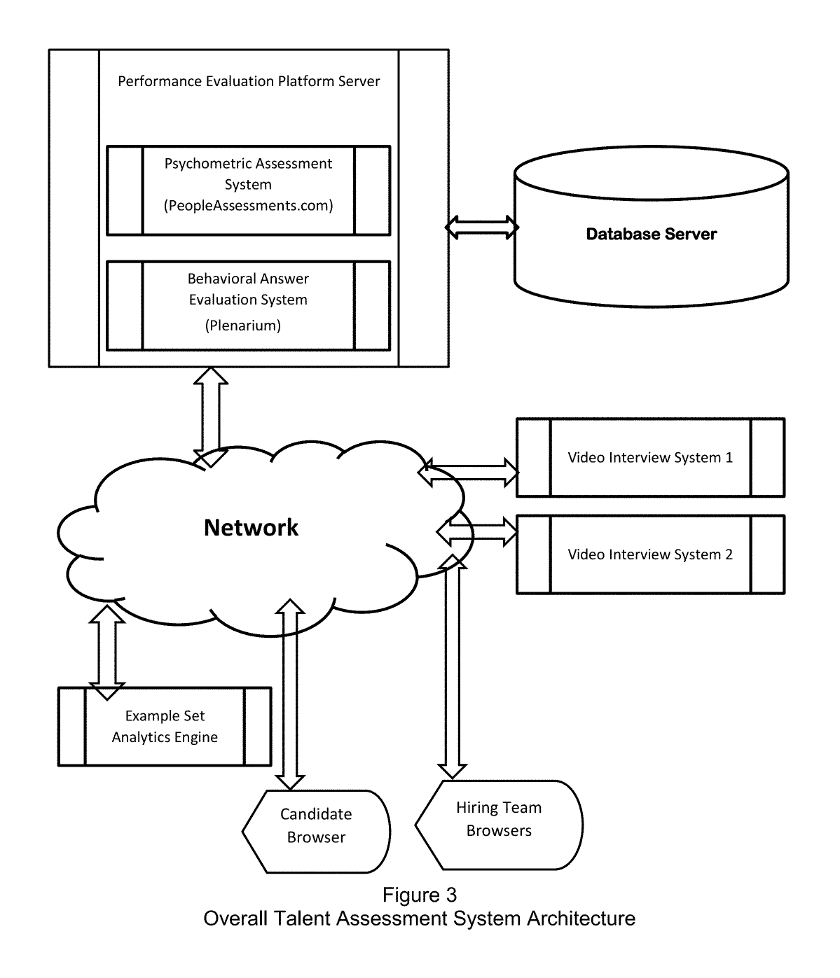

FIG. 3 shows a block diagram of an exemplary network architecture, in which embodiments of a model-driven candidate-sorting tool may operate.

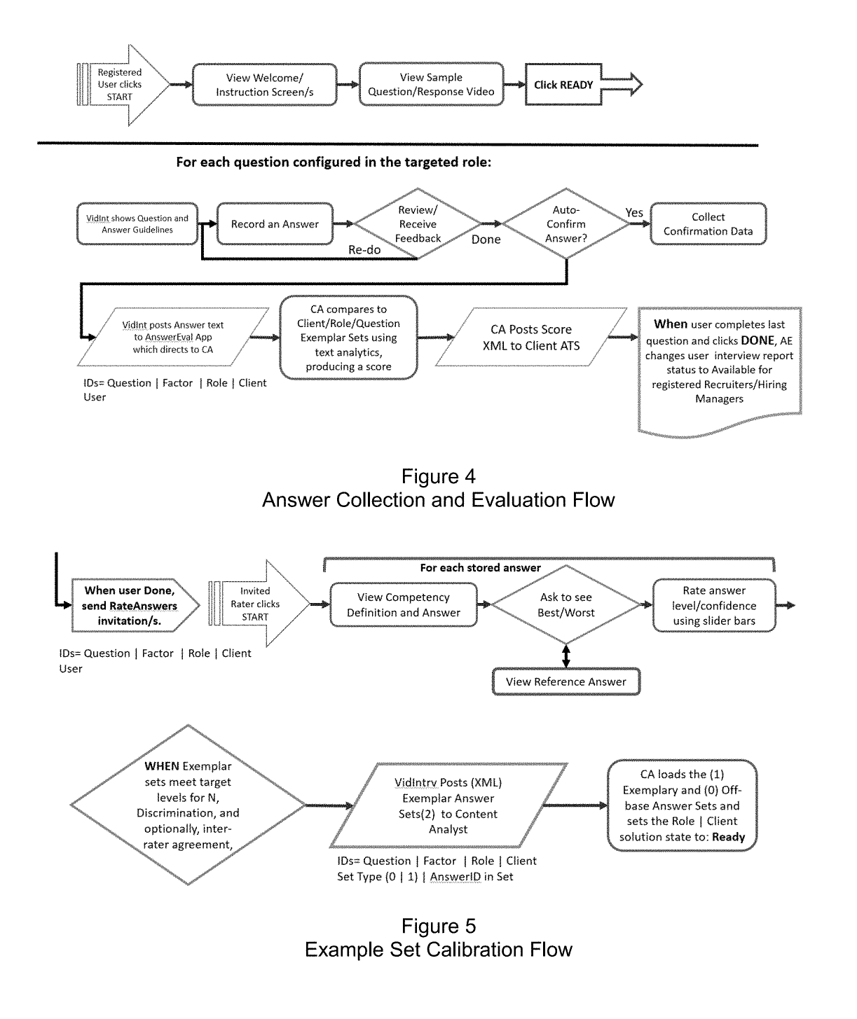

FIG. 4 is a block diagram of the answer evaluation phase of system operation during which interviewees are presented with questions that focus on their past behavior related to specific challenges they will face on-the-job, if hired, the answers are recorded, converted to text strings, and stored, and the stored text strings are transmitted to a SAAS service that performs latent semantic indexing on the answer text, indexing its similarity to stored sets of previous answers that have been evaluated as exemplars, typical, or ineffective, resulting in interviewee construct scores assembled into a predicted performance assessment report.

FIG. 5 illustrates the example set configuration module of the present system, that collects answers, obtains evaluation of those answers from job experts, and sorts answers with desirable performance characteristics into one of the three example sets to be used in scoring interviewee answers in real time.

While the present invention has been described in terms of the preferred embodiments, it should be understood that numerous modifications may be made thereto. It is intended that all such modifications fall within the scope of the appended claims.

What is claimed is:

1. A method of assessment of an human, comprising:
acquiring human communications comprising at least one of a video stream of an interviewee responding to a set of interview prompts and a corpus of documents authored or edited by the human;
determining at least a semantic content of the human communications;
statistically processing, with at least one automated processor, the semantic content of the human communications, to determine a correspondence of the analyzed human communications to a set of classified human communications comprising at least one of exemplar responses collected from prior interviewees' respective responses to corresponding respective interview prompts in a context, and classified corpuses of documents authored or edited by humans, to evaluate the human; and
generating at least one output selectively dependent on the statistical processing.

2. The method according to claim 1, wherein the human communications comprise interviewee responses to the set of interview prompts, and the evaluation of the human is with respect to at least one performance construct underlying the set of interview prompts, the at least one output selectively dependent on the statistical processing comprising at least one performance prediction.

3. The method according to claim 1, wherein the human communications comprise a corpus of documents, and the evaluation of the human is with respect to a characteristic of the human.

4. The method according to claim 1, wherein the statistical processing comprises clustering.

5. The method according to claim 2, wherein the human communications comprise interviewee responses to the set of interview prompts, comprising at least semantic content, visual cues, and timing of response, further comprising clustering according to a multimodal clustering algorithm.

6. The method according to claim 1, wherein the context comprises at least one of an employment opportunity and a potential coworker.

7. The method according to claim 1, wherein the semantic content is analyzed according to latent semantic indexing.

8. The method according to claim 1, further comprising producing at least one of a ranked list and an identification of a plurality of humans that meet threshold criteria dependent on the statistical processing.

9. The method according to claim 1, wherein said acquiring comprises automatically prompting an interviewee to generate the interviewee's respective responses, substantially without real-time involvement of an interviewer, and automatically producing a score of text analytics of a transcript of the interviewee's respective responses.

10. The method according to claim 1, wherein said statistical processing produces at least two non-binary ratings of independent characteristics of the human communications.

11. The method according to claim 1, wherein a plurality of human users each classify the same exemplar response collected from a prior interviewees' response to an interview prompt, or the same document, further comprising determining an inter-user agreement rating for the classification.

12. The method according to claim 11, further comprising determining a discrimination factor for the classification with respect to a non-binary rating.

13. The method according to claim 1, further comprising determining an accuracy of the evaluation of the human, and updating the statistical processing in dependence on the determined accuracy.

14. The method according to claim 1, further comprising receiving feedback information reflecting a performance of the human, and updating a statistical model for the statistical processing based on at least the feedback.

15. The method according to claim 1, wherein the human communications comprise the interviewee responding to the set of interview prompts, further comprising modifying the set of interview prompts, and a weighting of the interviewee's respective responses to the set of interview prompts, in the statistical processing, based on at least a performance the interviewee after the assessment.

16. The method according to claim 1, wherein the human communication comprise an email archive authored or edited by the human, further comprising producing at least one of a ranked list of email subjects and a subset of identifications of the email subjects that meet threshold criteria.

17. A method of assessment of an human, comprising:
determining at least a semantic content of a plurality of human communications involving a human;
statistically processing, with at least one automated processor, the semantic content of the plurality of human communications, to psychometrically classify the human communications with respect to a population; and
generating at least one output selectively dependent on the statistical processing.

18. The method according to claim 17, further comprising:
maintaining a database of classifications of a plurality of humans;
receiving at least one of a target psychometric profile for an assignment and information defining a target psychometric profile for an assignment;
automatically comparing the classifications of the plurality of humans with the at least one of the target psychometric profile for the assignment and information defining the target psychometric profile for the assignment; and
automatically generating at least one recommendation of a human for the assignment.

19. A system for characterizing an interviewee, comprising:
an input configured to receive an interviewee response to a performance-related behavioral prompt through an automated interviewee answer capture system;
at least one automated processor configured to automatically score information corresponding to the received interviewee response, based on at least latent semantic indexing of a text string, to statistically index a similarity of the received interviewee response to characterizations of a plurality of example sets from other interviewees to the performance-related behavioral prompt; and
at least one memory configured to store information characterizing the interviewee response with respect to the performance-related behavioral prompt based on the scoring.

20. The system according to claim 19, wherein the at least one automated processor is further configured to at least one of:
assess the interviewee's knowledge on a topic related to job performance;
assess a characteristic of an organization that employs the interviewee; and
assess a characteristic of a business opportunity raised by the specific prompts,
wherein the characterizations comprise classification criteria comprising meritorious, neutral, and counter-productive.
